(19) United States
(12) Patent Application Publication
(10) Pub. No.: US 2010/0111295 A1
(43) Pub. Date: May 6, 2010

(54) SWAP CIRCUIT FOR COMMON KEY BLOCK CIPHER AND ENCRYPTION/DECRYPTION CIRCUIT INCLUDING THE SAME

(75) Inventors: Souichi OKADA, Tokyo (JP); Masayoshi Isobe, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU MICROELECTRONICS LIMITED, Tokyo (JP)

(21) Appl. No.: 12/580,462

(22) Filed: Oct. 16, 2009

(30) Foreign Application Priority Data
Oct. 30, 2008 (JP) 2008-279028

(51) Int. Cl. H04L 9/28

(52) U.S. Cl. 380/28

(57) ABSTRACT

An encryption/decryption circuit includes a swap circuit for outputting each of text data and initialization vector data which are input from an input terminal to either a first or second output terminal in accordance with one of modes of operation, an encryption/decryption processing unit to which one of the text data and the initialization vector data are input from the first output terminal and which performs encryption processing and decryption processing on the data, and an exclusive OR processing unit to which another one of the initialization vector data and the text data are input from the second output terminal and which performs an exclusive OR operation on the data.

### CROSS-REFERENCE TO RELATED APPLICATIONS

This application is based upon and claims the benefit of priority of the prior Japanese Patent Application No. 2008-279028, filed on Oct. 30, 2008, the entire contents of which are incorporated by reference herein.

### FIELD

The present application relates to a swap circuit for a common key block cipher and an encryption/decryption circuit including the swap circuit.

### BACKGROUND

In the information society of today, encryption and decryption of information according to certain rules are practiced in various fields for protection against leakage, tampering, and/or unauthorized copying of important information. Encryption and decryption of information is also effected in the field of small portable information storage media, such as smart cards. Such cards and the like include an encryption/decryption circuit for realization of encryption and decryption.

One method of encryption is common key cryptography. Similar encryption circuits adopt Data Encryption Standard (DES) or Advanced Encryption Standard (AES) methods, which are representative standards of the United States. The DES and AES methods involve block encryption. Data to be encrypted, called plaintext, are encrypted into ciphertext in units of blocks and ciphertext is similarly decrypted into plaintext in units of blocks. The unit block for encryption and decryption is 64-bit long in DES and 128-bit long in AES. Also, both of the encryption methods define a number of modes of operation, and certain processes for encryption and decryption are performed in accordance with those modes. In such modes of operation, four modes are defined in DES, including Electronic Codebook (ECB), Cipher Block Chaining (CBC), Cipher Feedback (CFB), and Output Feedback (OFB) modes, and AES further defines a Counter (CTR) mode in addition to the four modes of DES.

Behaviors of the modes of operation defined in DES will be illustrated below using FIGS. 1 to 4. The figures conceptually illustrate encryption and decryption in the different modes of operation, the left half thereof representing the concept of encryption and the right half representing the concept of decryption. The figures illustrate how plaintext Pi is input, encrypted and output as ciphertext Ci, and ciphertext Ci is input, decrypted and output as plaintext Pi. Here, plaintext Pi and ciphertext Ci are in units of blocks for encryption and decryption as mentioned above, and the subscript “i” represents a sequential block number for divided plaintext to be encrypted or divided ciphertext to be decrypted. Also, for encryption of plaintext Pi and decryption of ciphertext Ci, an encryption parameter called an initialization vector Vi that is set in a register IV is used while being updated as appropriate. Intermediate data Di represents data that are generated during the processes of encryption or decryption. Also, an encryption processing unit Enc performs encryption processing on input data and a decryption processing unit Dec performs decryption processing on input data. Although not explicitly illustrated in the figures, a common key is used as a parameter in encryption and decryption processing.

FIG. 1 is a conceptual diagram of ECB mode. In encryption, input plaintext Pi is encrypted by the encryption processing unit Enc and output as ciphertext Ci.

In decryption, input ciphertext Ci is decrypted by the decryption processing unit Dec and output as plaintext Pi.

Expressions representing processing in ECB mode are illustrated below: Encryption: Ci=Enc(Pi) (i=1, 2, 3, . . . ) Decryption: Pi=Dec(Ci) (i=1, 2, 3, . . . ).

FIG. 2 is a conceptual diagram of CBC mode. In encryption, an initial value of initialization vector Vi is set in the register IV and used as initialization vector V1 for encryption of plaintext P1. Plaintext P1 is the first block of plaintext that has been divided into 64-bit long blocks. Then, an exclusive OR operation of plaintext P1 and initialization vector V1 is performed and intermediate data D1 is output. Then, intermediate data D1 is subjected to encryption processing in the encryption processing unit Enc and output as ciphertext C1. Then, for encryption of plaintext P2, i.e., the next block, ciphertext C1 is set in the register IV and used as initialization vector V2. Subsequently, the value in the register IV is updated and plaintext Pi is encrypted in units of blocks in a similar way.

In decryption, the initial value of initialization vector Vi is set in the register IV and used as initialization vector V1 for decryption of ciphertext C1. Ciphertext C1 is the first block of ciphertext divided into 64-bit long blocks. Next, ciphertext C1 is subjected to decryption processing in the decryption processing unit Dec and output as intermediate data D1. Then, an exclusive OR operation of intermediate data D1 and initialization vector V1 is performed, and plaintext P1 is output. Then, for decryption of ciphertext C2, i.e., the next block, ciphertext C1 is set in the register IV and used as initialization vector V2. Subsequently, the value in the register IV is updated and ciphertext Ci is decrypted in units of blocks in a similar way.

Expressions representing processing in CBC mode are illustrated below, where “XOR” indicates exclusive OR. Encryption:

| | |
|---|---|
| V1=[initial value] | (i=1) |

| | |
|---|---|
| Vi=Ci−1 | (i=2,3,...) |
| Ci=Enc(Pi XOR Vi) | (i=1,2,3,...) |

Decryption:

| | |
|---|---|
| V1=[initial value] | (i=1) |

| | |
|---|---|
| Vi=Ci−1 | (i=2,3,...) |
| Pi=Dec(Ci) XOR Vi | (i=1,2,3,...) |

FIG. 3 is a conceptual diagram of CFB mode. As mentioned above, in the DES method, plaintext data are divided into 64-bit blocks and encryption and decryption are performed in units of the blocks. In CFB mode, however, plaintext of a 64-bit long block is further divided into smaller blocks of k bits and encryption and decryption are performed in the smaller blocks. For carrying out such processing, bit operation processing, such as bit shifting, is further performed in CFB mode. While initialization vector Vi set in the register IV is always 64-bit long, 1-, 8-, or 64-bit length is generally used as the k-bit length for the plaintext data mentioned above. Thus, CFB mode will be described assuming that “n” and “k” illustrated in the conceptual diagram of CFB mode of FIG. 3 are 64 and 8, respectively.

In encryption, the initial value of initialization vector Vi is set in the register IV and used as initialization vector V1 for encryption of plaintext P1, the first block of plaintext divided into 8-bit long blocks. Next, the initialization vector V1 is subjected to encryption processing by the encryption processing unit Enc and output as intermediate data D1. Next, the high-order 8 bits of intermediate data D1 is taken, an exclusive OR operation of the 8 bits and plaintext P1 divided into 8-bit long blocks is performed, and 8-bit long ciphertext C1 is output. Then, a value that is concatenation of the low-order 56 bits of the 64-bit long initialization vector V1 mentioned above and the ciphertext C1 is set in the register IV and used as initialization vector V2 for encryption of the next plaintext, P2. Subsequently, the register IV is updated and plaintext Pi is encrypted in blocks in a similar way.

In decryption, the initial value of initialization vector Vi is set in register IV and used as initialization vector V1 for decryption of ciphertext C1, the first block of ciphertext divided into 8-bit long blocks. Next, initialization vector V1 is subjected to encryption processing by the encryption processing unit Enc and output as intermediate data D1. Next, the high-order 8 bits of intermediate data D1 is taken and an exclusive OR operation of the 8 bits and ciphertext C1 divided into 8-bit long blocks is performed, and 8-bit long plaintext P1 is output. Next, a value which is concatenation of the low-order 56 bits of the 64-bit long initialization vector V1 described above and the ciphertext C1 is set in the register IV and used as initialization vector V2 for decryption of the next ciphertext, C2. Subsequently, the register IV is updated and ciphertext Ci is decrypted in units of blocks in a similar way.

Expressions representing processing in CFB mode are illustrated below:

Encryption:

| | |
|---|---|
| V1=[initial value] | (i=1) |

| | |
|---|---|
| Vi=LSBn-k(Vi−1)\|Ci−1 | (i=2,3,...) |

| | |
|---|---|
| Di=MSBk(Enc(Vi)) | (i=1,2,3,...) |
| Ci=Pi XOR Di | (i=1,2,3,...) |

Decryption:

| | |
|---|---|
| V1=[initial value] | (i=1) |

| | |
|---|---|
| Vi=LSBn-k(Vi−1)\|Ci−1 | (i=2,3, ...) |

| | |
|---|---|
| Di=MSBk(Enc(Vi)) | (i=1,2,3, ...) |
| Pi=Ci XOR Di | (i=1,2,3, ...) |

FIG. 4 is a conceptual diagram of OFB mode. In encryption, the initial value of initialization vector Vi is set in the register IV and used as initialization vector V1 for encryption of plaintext P1. Plaintext P1 is the first block of plaintext divided into blocks. Next, initialization vector V1 is subjected to encryption processing by the encryption processing unit Enc and output as intermediate data D1. Next, an exclusive OR operation of intermediate data D1 and plaintext P1 is performed and C1 is output. Then, for encryption of plaintext P2, i.e., the next block, the intermediate data D1 mentioned above is set in the register IV and used as initialization vector V2. Subsequently, the register IV is updated and plaintext Pi is encrypted in units of blocks in a similar manner.

In decryption, the initial value of initialization vector Vi is set in the register IV and used as initialization vector V1 for decryption of ciphertext C1, the first block of ciphertext divided into blocks. Next, initialization vector V1 is subjected to encryption processing by the encryption processing unit Enc and output as intermediate data D1. Next, an exclusive OR operation of intermediate data D1 and ciphertext C1 is performed and P1 is output. Then, for decryption of ciphertext C2, i.e., the next block, the aforementioned intermediate data D1 is set in the register IV and used as initialization vector V2. Subsequently, the register IV is updated and ciphertext Ci is decrypted in units of blocks in a similar manner.

Expressions representing processing in OFB mode are illustrated below:

Encryption:

| | |
|---|---|
| V1=[initial value] | (i=1) |

| | |
|---|---|
| Vi=Di−1 | (i=2,3,...) |
| Di=Enc(Vi) | (i=1,2,3, ...) |
| Ci=Pi XOR Di | (i=1,2,3, ...) |

Decryption:

| | |
|---|---|
| V1=[initial value] | (i=1) |

| | |
|---|---|
| Vi=Di−1 | (i=2,3, ...) |
| Di=Enc(Vi) | (i=1,2,3, ...) |
| Pi=Ci XOR Di | (i=1,2,3, ...) |

As described above, the DES method has the four modes of operation for performing encryption and decryption with different behaviors. And encryption/decryption circuits for use in small portable information storage media, such as smart cards, may be required to support all of these modes of operation, and moreover, to be small in size.

Japanese Patent Laid-Open No. 2000-75785 discusses an encryption circuit that is capable of implementing both the CBC and CFB modes of the DES method with a special circuit configuration.

Japanese Patent Laid-Open No. 2004-126323 discusses that processing by a host computer, including access processing, is reduced by isolating and separating encryption processing from the host computer.

Japanese Patent Laid-Open No. 2006-330126 discusses that overwriting of plaintext data which is caused by special processing on a break of encryption chain is eliminated by providing a buffer that can read in multiple blocks of plaintext data divided into blocks at a time and loading blocks less than can be read into the buffer.

However, because encryption/decryption processing and exclusive OR operation that are performed on plaintext and an initialization vector are different in order and combination depending on an operation mode in conventional techniques as mentioned above, an encryption/decryption circuit cannot be made small in size, due to the inclusion of circuits for all of the different modes of operation.

### SUMMARY

According to an aspect of the embodiment, an encryption/decryption circuit includes a swap circuit for outputting each of text data and initialization vector data which are input from an input terminal to either a first or second output terminal in accordance with one of modes of operation, an encryption/decryption processing unit to which one of the text data and the initialization vector data are input from the first output terminal and which performs encryption processing and decryption processing on the data, and an exclusive OR processing unit to which another one of the initialization vector data and the text data are input from the second output terminal and which performs an exclusive OR operation on the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 illustrates ECB mode;

FIG. 2 illustrates CBC mode;

FIG. 3 illustrates CFB mode;

FIG. 4 illustrates OFB mode;

FIG. 5 illustrates an example of system configuration for performing encryption and decryption according to the embodiments;

FIG. 6 illustrates a flowchart of encryption processing in the CBC, CFB and OFB modes in the embodiments;

FIG. 7 illustrates an example of a swap circuit for use in an encryption circuit according to a first embodiment;

FIG. 8 illustrates an encryption/decryption circuit that uses a swap circuit 90 in FIG. 7;

FIG. 9 illustrates an example of circuit for the encryption/decryption circuit in FIG. 8;

FIG. 10 illustrates operation of the encryption/decryption circuit of the first embodiment in encryption and decryption in ECB mode;

FIG. 11 illustrates operation of the encryption/decryption circuit of the first embodiment in encryption in CBC mode;

FIG. 12 illustrates operation of the encryption/decryption circuit of the first embodiment in decryption in CBC mode;

FIG. 13 illustrates operation of the encryption/decryption circuit of the first embodiment in encryption in CFB mode;

FIG. 14 illustrates operation of the encryption/decryption circuit of the first embodiment in decryption in CFB mode;

FIG. 15 illustrates operation of the encryption/decryption circuit of the first embodiment in encryption and decryption in OFB mode;

FIG. 16 illustrates an example of a swap circuit for use in an encryption circuit according to a second embodiment;

FIG. 17 illustrates an example of a selector circuit for the swap circuit in FIG. 16 according to the second embodiment;

FIG. 18 illustrates an example of an encryption/decryption circuit that uses the swap circuit 95 in FIG. 16;

FIG. 19 illustrates an example of circuit for the encryption/decryption circuit in FIG. 18;

FIG. 20 illustrates operation of the encryption/decryption circuit of the second embodiment in encryption and decryption in ECB mode;

FIG. 21 illustrates operation of the encryption/decryption circuit of the second embodiment in encryption in CBC mode;

FIG. 22 illustrates operation of the encryption/decryption circuit of the second embodiment in decryption in CBC mode;

FIG. 23 illustrates operation of the encryption/decryption circuit of the second embodiment in encryption in CFB mode;

FIG. 24 illustrates operation of the encryption/decryption circuit of the second embodiment in decryption in CFB mode; and

FIG. 25 illustrates operation of the encryption/decryption circuit of the second embodiment in encryption and decryption in OFB mode.

### DESCRIPTION OF THE EMBODIMENTS

Reference may now be made in detail to embodiments of the present invention, examples of which are illustrated in the accompanying drawings, wherein like reference numerals refer to like elements throughout.

Hereinafter, embodiments will be described with respect to drawings. However, the technical scope is not limited to those embodiments and is intended to encompass matters set forth in CLAIMS and equivalents thereof.

While an encryption/decryption circuit for DES is illustrated in relation to the embodiments, similar embodiments may be also possible for the AES method.

As mentioned above, in the DES method, encryption/decryption processing and exclusive OR operation are performed on plaintext and an initialization vector, and their order and combination vary in different modes of operation. For that reason, an encryption/decryption circuit capable of supporting all the modes of operation includes an encryption/decryption processing unit and an exclusive OR processing unit. Plaintext and an initialization vector are input to the encryption/decryption processing unit and the exclusive OR processing unit in accordance with requirements of each of the modes of operation. Hereinafter, plaintext divided into blocks for encryption or ciphertext divided into blocks for decryption which are input to the encryption/decryption circuit of the embodiments will be called TEXT data, and an initialization vector will be called IV data. Also, data that are output being encrypted or decrypted will be referred to as encrypted data and decrypted data, respectively.

To start with, which input data, namely TEXT data or IV data, are directly subjected to encryption or decryption processing will be described with reference to the description of the modes of operation provided above. In ECB mode, IV data are not used and TEXT data undergo encryption or decryption processing. In CBC mode, no input data are directly subjected to encryption processing, but TEXT data are subjected to decryption processing in decryption. In CFB and OFB modes, IV data are subjected to encryption or decryption processing.

For realization of such operations, the encryption/decryption circuit according to the embodiments includes a swap circuit for switching data in accordance with an operation mode. Hereby, TEXT data are input to the encryption/decryption processing unit in ECB and CBC modes, and IV data are input to the encryption/decryption processing unit in CFB and OFB modes.

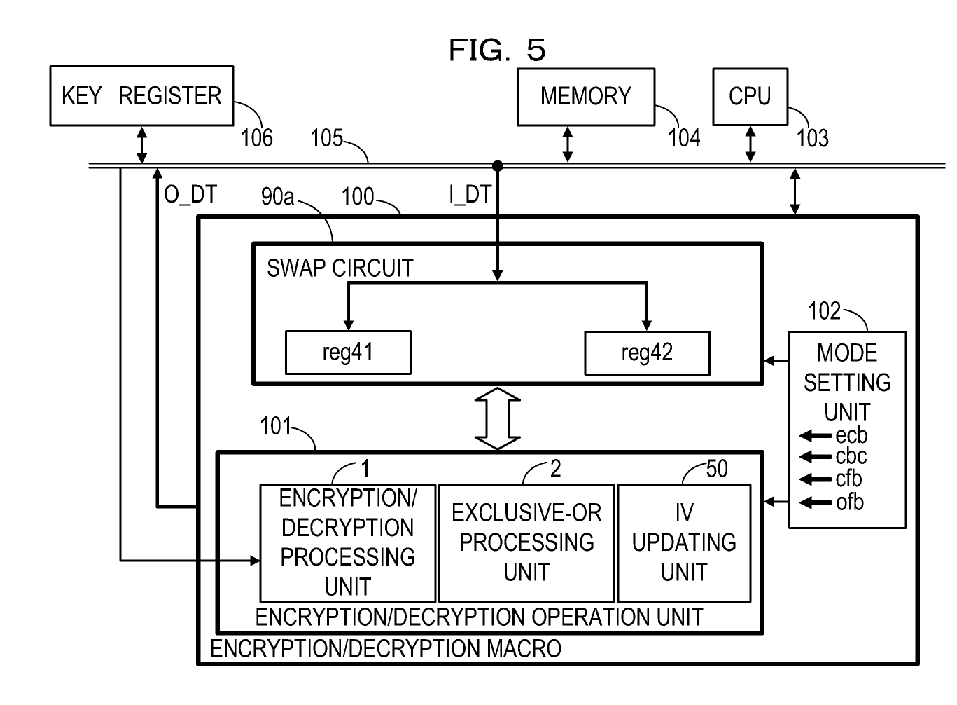

FIG. 5 illustrates an example configuration of a system for performing encryption and decryption according to the embodiments. An encryption/decryption macro 100, memory 104, and a key register 106 are controlled by a CPU 103 via a bus 105, and encryption and decryption are performed by the encryption/decryption macro 100. The encryption/decryption macro 100 has a swap circuit 90a, an encryption/decryption operation unit 101, and a mode setting unit 102. The swap circuit 90a has a register reg41 and a register reg42 in which either TEXT data or IV data which is input from the memory 104 as input data I_DT is set. The encryption/decryption operation unit 101 further has an encryption/decryption processing unit 1 and an exclusive OR processing unit 2, which are described above. The encryption/decryption operation unit 101 also has an IV updating unit 50 which updates IV data for a second and subsequent block encryption in a sequence of encryption. The mode setting unit 102 sends operation mode signals, ecb, cbc, cfb, and ofb, which correspond to the different modes of operation, to the swap circuit 90a and the encryption/decryption operation unit 101. Then, in response to the operation mode signals, data defined for a corresponding mode is input from the registers of the swap circuit 90a to the encryption/decryption processing unit 1 and the exclusive OR processing unit 2 of the encryption/decryption operation unit 101. For encryption and decryption, a key as a parameter is used, and the encryption/decryption processing unit 1 uses the key to perform an encryption or decryption operation.

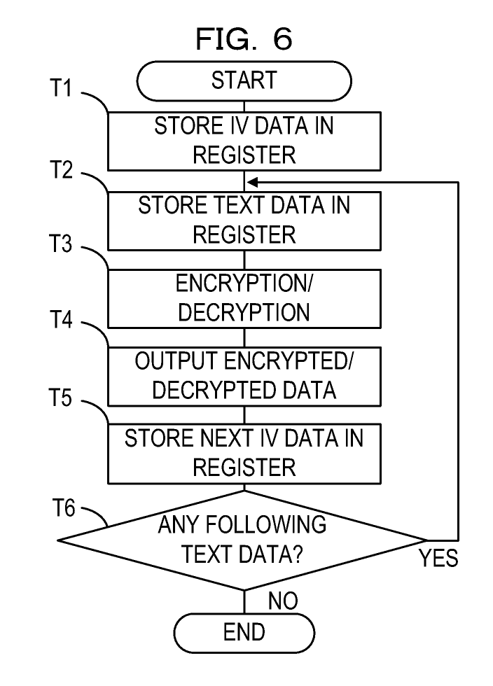

Now, operations of the encryption/decryption system of FIG. 5 are described using the flowchart illustrated in FIG. 6. FIG. 6 is a flowchart illustrating a flow of encryption and decryption processing in CBC, CFB, and OFB modes.

In FIG. 5, an operation mode signal corresponding to mode setting is being asserted from the mode setting unit 102 to the swap circuit 90a and the encryption/decryption operation unit 101.

For the first encryption or decryption of TEXT data, the initial value of IV data are input as input data I_DT from the memory 104 and set in the register reg41 (step T1). Then, TEXT data are input from the memory 104 as input data I_DT and set in the register reg42 (step T2).

In the encryption/decryption macro 100, the data set in the registers at steps T1 and T2 is each input to a corresponding one of the processing units 1 and 2 in accordance with requirements of the operation mode of interest with function of the swap circuit 90a to be encrypted or decrypted (step T3).

Then, encrypted or decrypted data are output as output data O_DT and stored in the memory 104 by way of the bus 105 (step T4).

Then, for the next encryption/decryption of TEXT data, the IV updating unit 50 updates IV data in accordance with requirements of the operation mode of interest. The updated IV data are set in the register reg41, i.e., the similar register as the one in which IV data was set at step T1 (step T5).

Then, when there is subsequent TEXT data to be encrypted or decrypted, processing is moved to step T2, and when there is no subsequent TEXT data, processing is terminated (step T6).

While encryption and decryption are performed as described in the embodiments, actual configuration and flow of processing are not limited thereto.

### First Embodiment

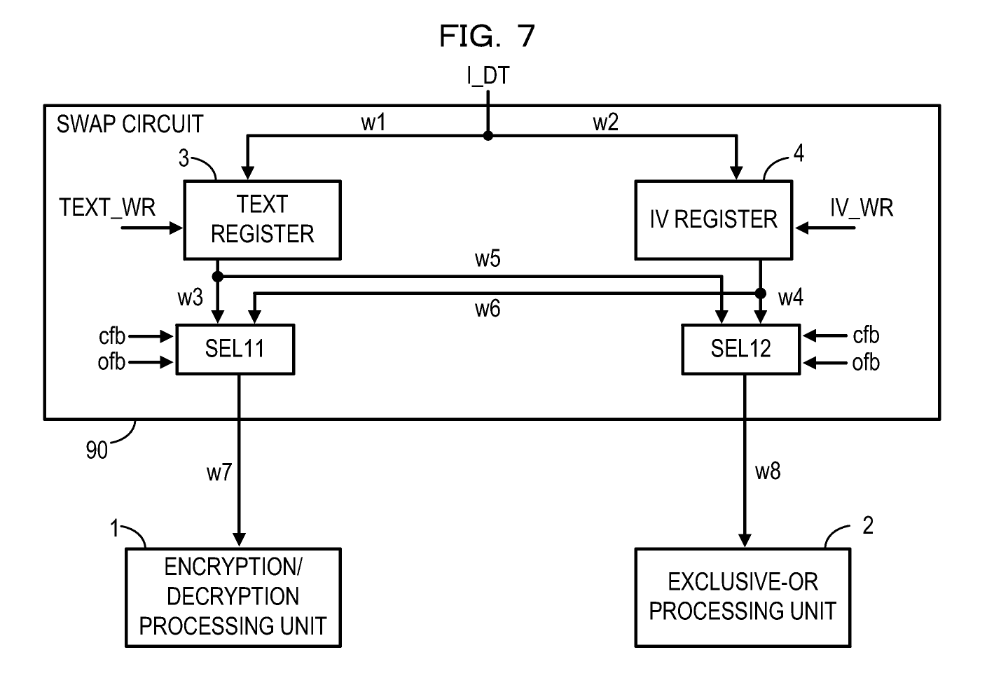

FIG. 7 illustrates a configuration of a swap circuit for use in an encryption/decryption circuit of a first embodiment. A swap circuit 90 includes a TEXT register 3, an IV register 4, a selector SEL11, and a selector SEL12. Reference numerals w1 to w8 denote paths or data that is sent on the paths.

An overview of the first embodiment will be described first. The swap circuit 90 has the TEXT register 3 and the IV register 4 as dedicated registers in which TEXT data and IV data, which are input data I_DT, are set. The swap circuit 90 swaps data set in the registers using the selectors SEL11 and SEL12 in accordance with requirements of an operation mode so that the data are input to either the encryption/decryption processing unit 1 or the exclusive OR processing unit 2. In other words, in the swap circuit 90, a register for setting TEXT data and one for IV data are fixed and destination of data set in the registers is changed in accordance with an operation mode.

Now, operations of the components of the swap circuit 90 will be described. The TEXT register 3 and IV register 4 are dedicated registers in which TEXT data and IV data as input data I_DT are set, respectively. Individual pieces of input data I_DT are input from the similar path. Then, into the TEXT register 3, TEXT data are set via the path w1 in response to assertion of TEXT-data write enable signal, TEXT_WR. Likewise, into the IV register 4, IV data are set via the path w2 in response to assertion of IV-data write enable signal, IV_WR.

The selectors SEL11 and SEL12 have the similar bit length as the registers 3 and 4, and select either TEXT data set in the TEXT register 3 or IV data set in the IV register 4 and output the selected data to their respective processing unit. The selector SEL11 also performs OR operation of CFB mode signal, cfb, and OFB mode signal, ofb, with the two signals as control input. Hereinafter, an operational expression “|” represents OR. When an operation value (cfb|ofb) is 0, the selector SEL11 selects the TEXT register 3, causing TEXT data to be input to the encryption/decryption processing unit 1 via paths w3 and w7. When the operation value (cfb|ofb) is 1, the selector SEL11 selects the IV register 4, causing IV data to be input to the encryption/decryption processing unit 1 via paths w6 and w7. That is to say, when either one of operation signals cfb and ofb is “1”, which means being effective, IV data in the IV register 4 is input to the encryption/decryption processing unit 1. Likewise, when the operation value (cfb|ofb)=0, the selector SEL12 selects the IV register 4, causing IV data to be input to the exclusive OR processing unit 2 via paths w4 and w8. When the operation value (cfb|ofb)=1, the selector SEL12 selects the TEXT register 3, causing TEXT data to be input to the exclusive OR processing unit 2 via paths w5 and w8.

The encryption/decryption processing unit 1 performs encryption or decryption processing on input data w7, and the exclusive OR processing unit 2 performs exclusive OR processing on input data w8.

Next, certain operations of the swap circuit 90 in different modes of operation will be described. First, in response to assertion of IV-data write enable signal IV_WR to the IV register 4, IV data are set into the IV register 4 via path w2 as input data I_DT. And in response to assertion of TEXT-data write enable signal TEXT_WR to the TEXT register 3, TEXT data are set in the TEXT register 3 via path w1 as input data I_DT.

Then, in CBC mode, the operation value (cfb|ofb) is 0, so that the selector SEL11 selects the TEXT register 3 and the selector SEL12 selects the IV register 4. Accordingly, the TEXT data are input to the encryption/decryption processing unit 1 via paths w3 and w7, and the IV data are input to the exclusive OR processing unit 2 via paths w4 and w8.

In CFB or OFB mode, the operation value (cfb|ofb) is 1, so that the selector SEL11 selects the IV register 4 and the selector SEL12 selects the TEXT register 3. Accordingly, the IV data are input to the encryption/decryption processing unit 1 via paths w6 and w7 and the TEXT data are input to the exclusive OR processing unit 2 via paths w5 and w8.

Next, a configuration of an encryption circuit that uses the swap circuit 90 and is capable of supporting all the modes of operation of DES will be described.

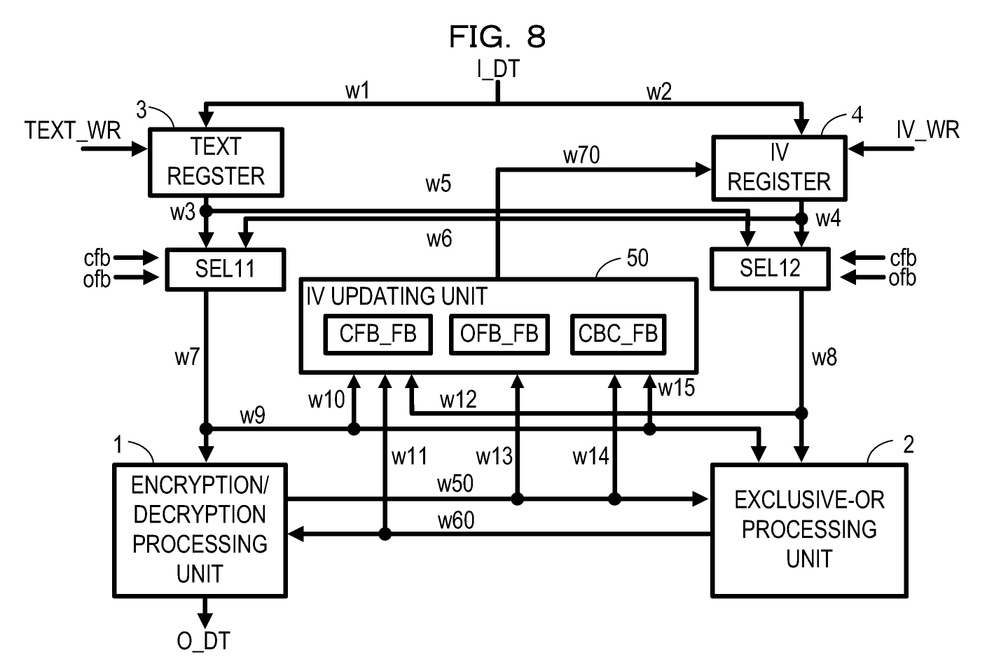

FIG. 8 schematically illustrates an encryption circuit configured with the swap circuit 90 that is capable of supporting all of the four modes of operation of DES. Reference numerals w1, w2 . . . denote paths or data that is sent on the paths.

Data input to the encryption/decryption unit 1 or the exclusive OR processing unit 2 described above is passed between the units via paths w50 and w60 in accordance with requirements of each operation mode, is encrypted or decrypted, and output as data O_DT.

The IV updating unit 50 updates IV data in accordance with requirements of each operation mode and sets the updated IV data in the IV register 4 via path w70. That is to say, when IV data are updated with a result of operation or the like of the last encryption or decryption during the second and subsequent encryption or decryption of TEXT data in CBC, CFB, and OFB modes, the IV updating unit 50 performs this updating of IV data in the encryption circuit of the present embodiment. The IV updating unit 50 includes a CFB feedback section CFB_FB, an OFB feedback section OFB_FB, and a CBC feedback section CBC_FB which perform IV updating in accordance with each operation mode with data w10 to w15 as input.

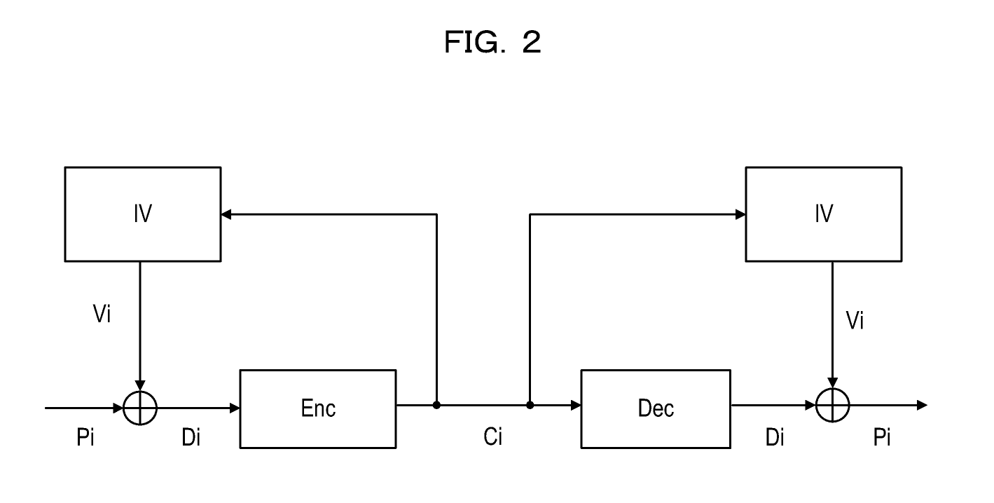

Data input paths to the IV register 4 are path w2 and path w70. That is to say, IV data for use in the first encryption is set in the IV register 4 via path w2, and IV data for use in the second and subsequent encryption is updated by the IV updating unit 50 and set in the IV register 4 via path w70 as mentioned above. In encryption in CBC mode, for example, ciphertext Ci that has been subjected to encryption processing in the encryption processing unit Enc is set in the register IV as illustrated in the block diagram of FIG. 2. In a similar way, in FIG. 8, data encrypted by the encryption/decryption processing unit 1, which corresponds to the ciphertext Ci, is input to the CBC feedback section CBC_FB of the IV updating unit 50 via paths w50 and w14 and set into the IV register 4 via path w70. Likewise, in decryption in CBC mode, ciphertext Ci is set in the register IV as illustrated in the block diagram of FIG. 2. In FIG. 8, TEXT data to be decrypted, which corresponds to the ciphertext Ci, is input to the CBC feedback section CBC_FB of the IV updating unit 50 via paths w3, w7, w9, and w15, and set in the IV register 4 via path w70.

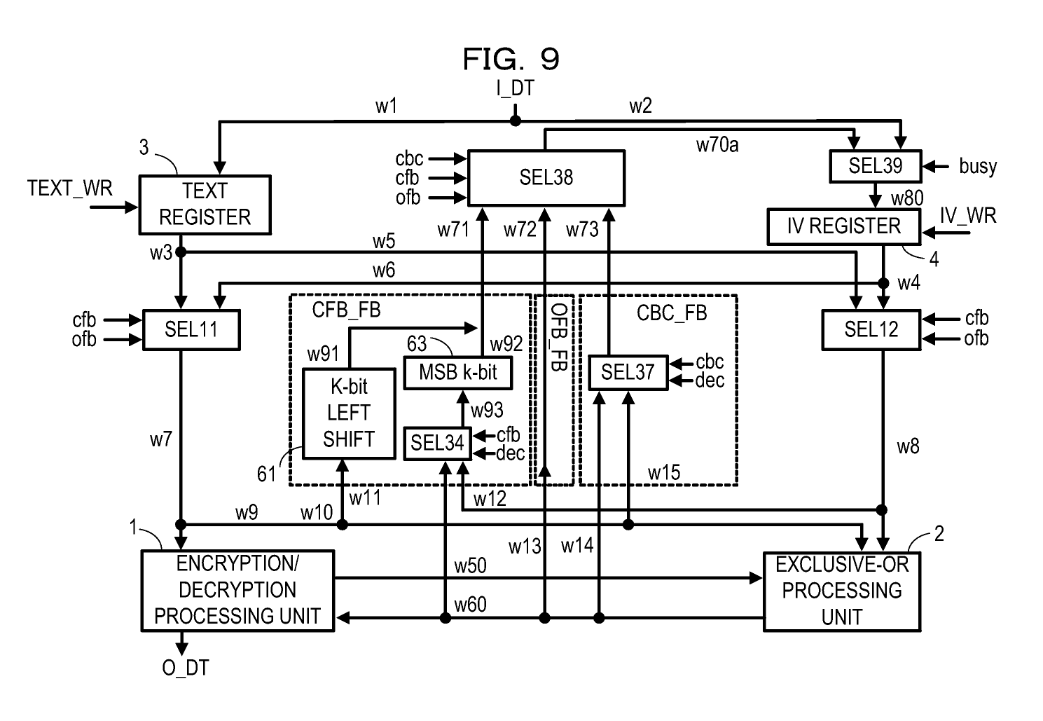

FIG. 9 illustrates an example of circuit configuration for the schematic diagram of FIG. 8. Portions indicated by dotted lines in FIG. 9 correspond to the CFB feedback section CFB_FB, OFB feedback section OFB_FB, and CBC feedback section CBC_FB of FIG. 8, and the feedback sections output updated IV data w71 to w73 which will be used in the next encryption to the selector SEL38. The selector SEL38 outputs one of updated IV data w71 to w73 as data w70a in accordance with CBC mode signal cbc, CFB mode signal cfb, and OFB mode signal ofb with those signals as control input. Detailed operations of the feedback sections CFB_FB, OFB_FB, and CBC_FB will be illustrated below.

A selector SEL39 outputs input data w2 as data w80 when busy=0 and outputs input data w70a as data w80 when busy=1, with busy signal as control input. Thus, IV data are set in the IV register 4 via path w2 in the first encryption by making busy=0, and after an encryption operation is started, is set in the IV register 4 via path w70a by making busy=1 at all times.

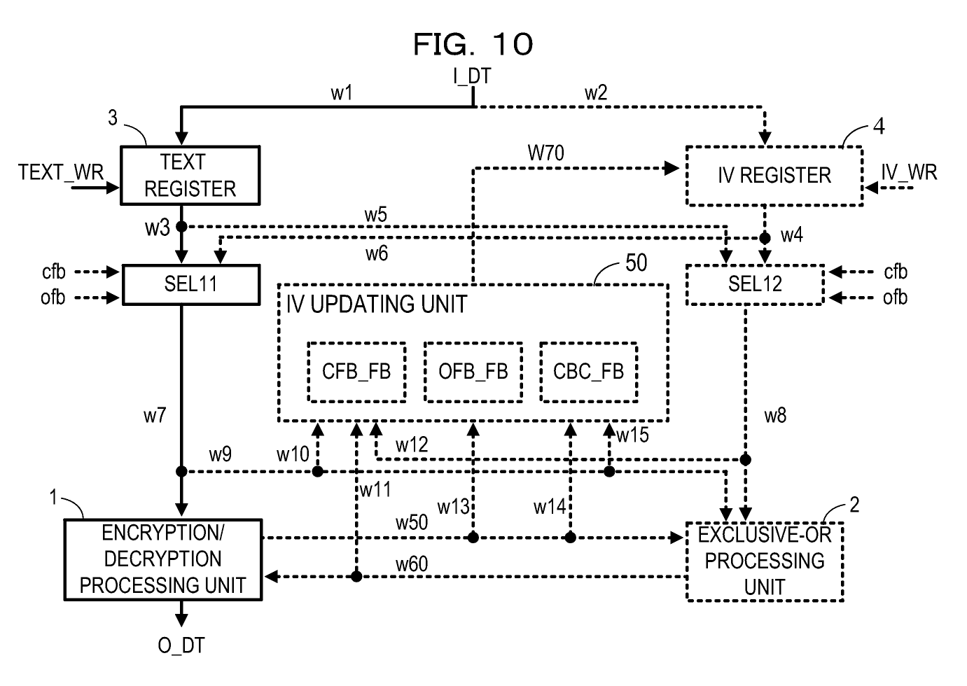

Operations in the different modes of operation will be described using FIG. 8 and with respect to FIGS. 10 to 15. In the figures, only paths that are used for data transmission during operation, operation mode signals that are asserted, and components that operate are illustrated by solid lines and other portions are illustrated by dotted lines. Operation of the IV updating unit 50 is described also using an example of FIG. 9.

ECB Mode

FIG. 10 illustrates operations of the encryption/decryption circuit of the first embodiment in encryption and decryption in ECB mode.

In encryption, TEXT data are set into the TEXT register 3 via path w1 in response to assertion of TEXT-data write enable signal, TEXT_WR. In ECB encryption mode, the operation value (cfb|ofb) for operation mode signals is 0 and the selector SEL11 selects path w3. Accordingly, TEXT data are input to the encryption/decryption unit 1 via paths w3 and w7, encrypted, and output as encrypted data O_DT. Subsequently, TEXT data are set in the TEXT register 3, encrypted by the encryption/decryption processing unit 1, and output as encrypted data O_DT in a similar manner.

Meanwhile, in decryption, TEXT data, which is ciphertext, is set into the TEXT register 3 via path w1 in response to assertion of TEXT-data write enable signal TEXT_WR. In ECB decryption mode, the operation value for operation mode signals (cfb|ofb) is 0, so that the selector SEL11 selects path w3. Accordingly, TEXT data are input to the encryption/decryption processing unit 1 via paths w3 and w7, decrypted, and output as decrypted data O_DT. Subsequently, TEXT data are set in the TEXT register 3, decrypted by the encryption/decryption processing unit 1, and output as decrypted data O_DT in a similar way.

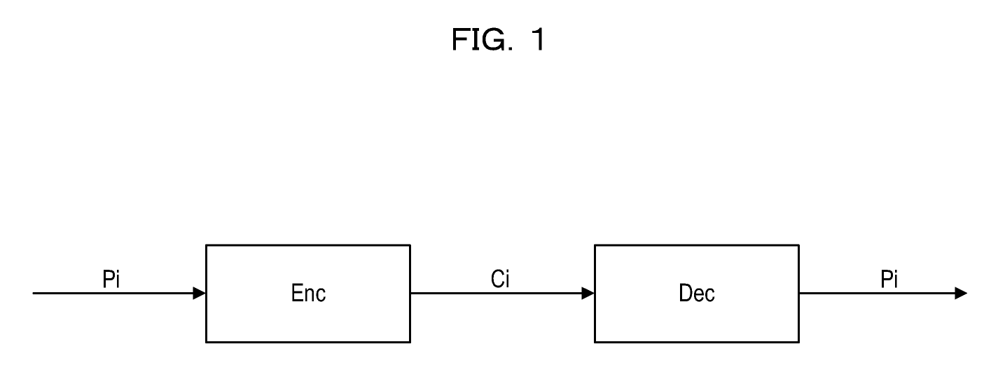

The operations illustrated above correspond with the behavior of ECB mode described in FIG. 1. In ECB mode, IV data are not used and IV updating unit 50 does not operate.

CBC Mode

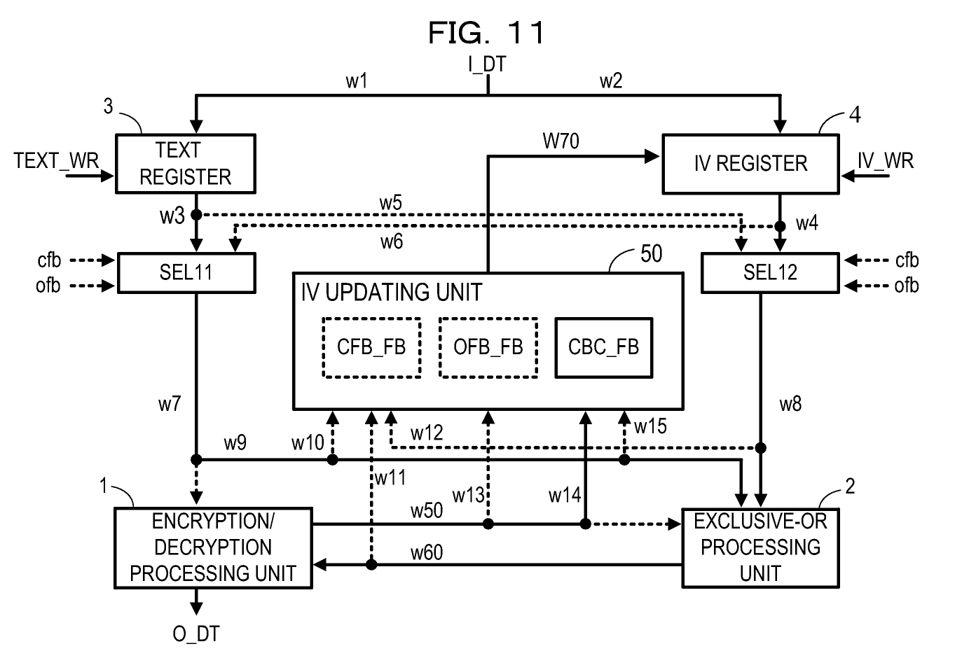

FIG. 11 illustrates operations of the encryption/decryption circuit of the first embodiment in CBC mode encryption.

In encryption, for the first encryption of TEXT data, the initial value of IV data are set into the IV register 4 via path w2 in response to assertion of IV-data write enable signal IV_WR. Next, TEXT data are set into the TEXT register 3 via path w1 in response to assertion of TEXT-data write enable signal TEXT_WR. In CBC encryption mode, the operation value for operation mode signals (cfb|ofb) is 0, so that the selector SEL11 selects path w3 and the selector SEL12 selects path w4.

Then, the TEXT data are input via paths w3, w7 and w9 and the IV data are input via paths w4 and w8 to the exclusive OR processing unit 2, and an exclusive OR operation of the two is performed therein. Then, resulting data w60, which corresponds to intermediate data Di of FIG. 2, is input to the encryption/decryption processing unit 1, subjected to encryption processing, and output as encrypted data O_DT.

Then, for the next encryption of TEXT data, the encrypted data O_DT mentioned above is input to the CBC feedback section CBC_FB of the IV updating unit 50 via paths w50 and w14, and set into the IV register 4 via path w70 in response to assertion of IV-data write enable signal IV_WR. Next, into the TEXT register 3, TEXT data are set via path w1 in response to assertion of TEXT-data write enable signal TEXT_WR. Subsequently, encryption is repeated in a similar way.

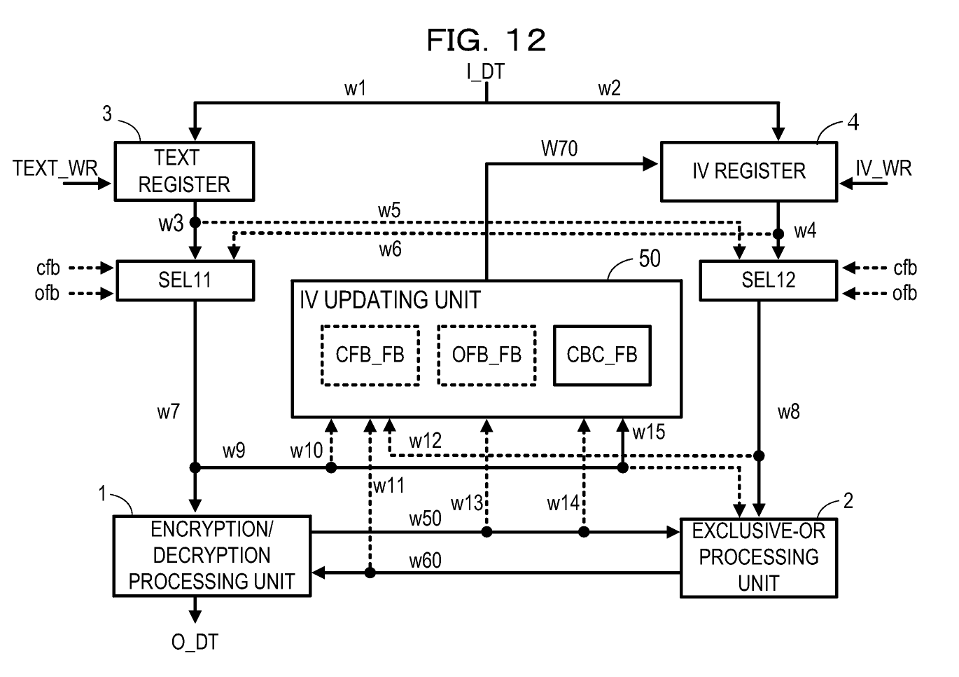

FIG. 12 illustrates operations of the encryption/decryption circuit of the first embodiment in decryption in CBC mode.

In decryption, for the first decryption of TEXT data, the initial value of IV data are set into the IV register 4 via path w2 in response to assertion of IV-data write enable signal IV_WR. Next, TEXT data, which is ciphertext, is set into the TEXT register 3 via path w1 in response to assertion of TEXT-data write enable signal TEXT_WR. In CBC decryption mode, the operation value for operation mode signals (cfb|ofb) is 0, so that the selector SEL11 selects path w3 and the selector SEL12 selects path w4.

Then, the TEXT data are input to the encryption/decryption processing unit 1 via paths w3 and w7 to be subjected to decryption processing therein, and data w50 corresponding to the intermediate data Di of FIG. 2 is input to the exclusive OR processing unit 2. Also, the IV data are input to the exclusive OR processing unit 2 via paths w4 and w8, and an exclusive OR operation of the IV data and the TEXT data which were subjected to the decryption processing is performed. Then, resulting decrypted data are sent to the encryption/decryption processing unit 1 via path w60 and output as decrypted data O_DT.

Then, for the next decryption of TEXT data, the TEXT data in the TEXT register 3 is input to the CBC feedback section CBC_FB of the IV updating unit 50 via paths w3, w7, w9 and w15, and set into the IV register 4 via path w70 in response to assertion of IV-data write enable signal IV_WR. Next, into the TEXT register 3, TEXT data are set via path w1 in response to assertion of TEXT-data write enable signal TEXT_WR. Subsequently, decryption is repeated in a similar manner.

Here, the CBC feedback section CBC_FB, which is common in FIGS. 8 and 9, is described. In FIG. 9, a selector SEL37 switches between encrypted data w14 at the time of encryption and TEXT data w15 at the time of decryption with operation mode signals cbc and dec as control input. That is to say, during CBC encryption, the selector SEL37 outputs input data w14 as data w73 in response to assertion of CBC mode signal cbc, and during CBC decryption, it outputs input data w15 as data w73 in response to assertion of CBC mode signal cbc and DEC signal dec.

The operations illustrated above correspond with the behavior of CBC mode described in FIG. 2.

CFB Mode

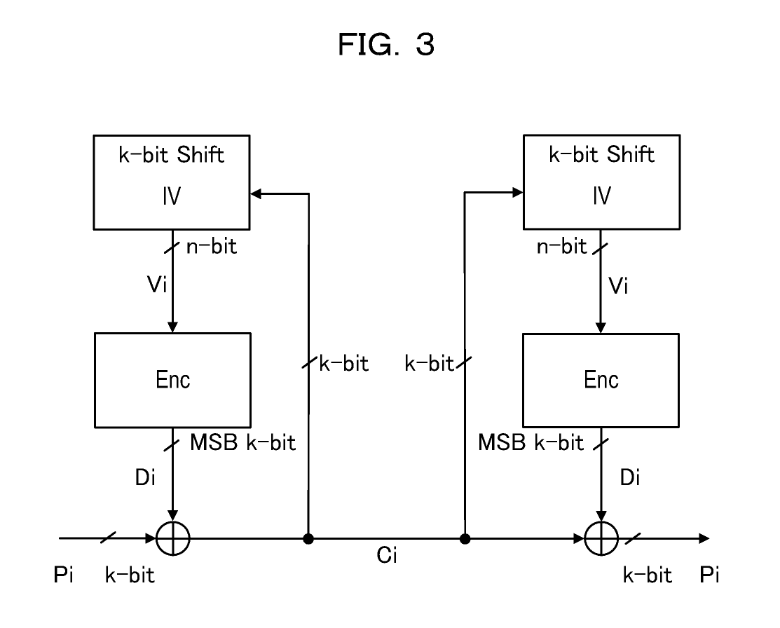

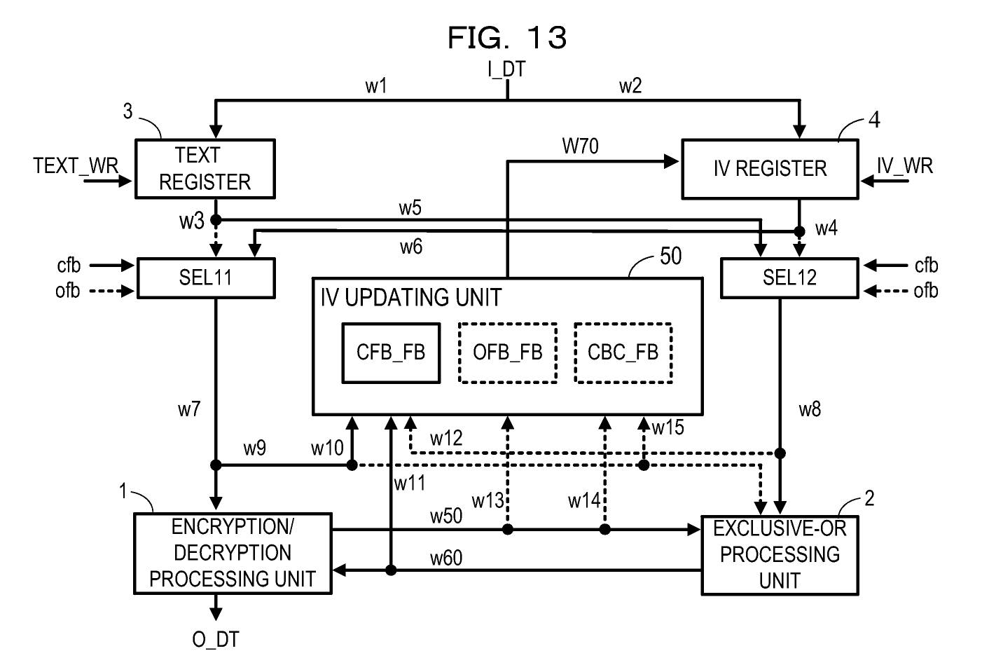

FIG. 13 illustrates operations of the encryption/decryption circuit of the first embodiment in encryption in CFB mode. As described in FIG. 3, in CFB mode, 64-big long TEXT data are further divided into k-bit blocks and is encrypted in units of k bits. Thus, in the operations of the encryption/decryption circuit of the present embodiment in CFB mode illustrated below, each processing is performed on 64-bit long data but only high-order k bits of data are regarded as an effective value of encrypted data. For example, effective TEXT data are set into the high-order k bits of the TEXT register and 0 values, for example, are set in the remaining low-order bits, and encryption of 64-bit long data are performed. Only high-order k bits of 64-bit long encrypted data are regarded as the effective value. Alternatively, it may be also possible to create 64-bit long TEXT data with its high-order k bits being effective TEXT data and remaining low-order bits being 0 values before input, and enter and set the 64-bit long data in the TEXT register.

In encryption, for the first encryption of TEXT data, the initial value of 64-bit long IV data are set into the IV register 4 via path w2 in response to assertion of IV-data write enable signal IV_WR. Next, k-bit long TEXT data are set into the high-order k bits of the TEXT register 3 via path w1 in response to assertion of TEXT-data write enable signal TEXT_WR and 0 values are set in the remaining low-order bits. In CFB encryption mode, the operation value for operation mode signals (cfb|ofb) is 1, so that the selector SEL11 selects path w6 and the selector SEL12 selects path w5.

The IV data are then input to the encryption/decryption processing unit 1 via paths w6 and w7 to be subjected to encryption processing therein, and data w50 which corresponds to the intermediate data Di of FIG. 3 is input to the exclusive OR processing unit 2. The TEXT data are also input to the exclusive OR processing unit 2 via paths w5 and w8, and an exclusive OR operation of the TEXT data and the IV data w50 which were subjected to the encryption processing is performed. Then, resulting encrypted data are sent to the encryption/decryption processing unit 1 via path w60 and high-order k bits as the effective value is output as encrypted data O_DT.

Then, for the next encryption of TEXT data, the IV data in the IV register 4 is input via paths w6, w7, w9 and w10, and the encrypted data mentioned above is input via paths w60 and w11 to the CFB feedback section CFB_FB of the IV updating unit 50, are subjected to bit processing, and set into the IV register 4 via path w70 in response to assertion of IV-data write enable signal IV_WR. Bit processing in the CFB feedback section CFB_FB is discussed later. Next, the following k-bit TEXT data are set into the high-order k bits of the TEXT register 3 via path w1 in response to assertion of TEXT-data write enable signal TEXT_WR and 0 values are set in the remaining low-order bits. Subsequently, encryption is repeated in a similar way.

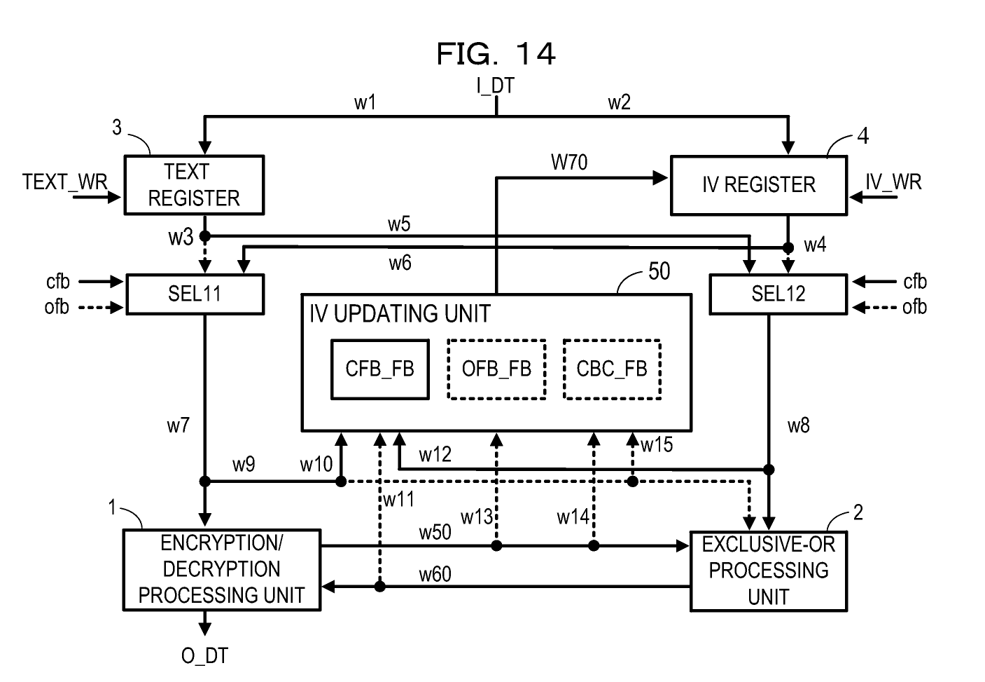

FIG. 14 illustrates operations of the encryption/decryption circuit of the first embodiment in decryption in CFB mode.

In decryption, for the first decryption of TEXT data, the initial value of 64-bit long IV data are set into the IV register 4 via path w2 in response to assertion of IV-data write enable signal IV_WR. Then, into the high-order k bits of the TEXT register 3, k-bit long TEXT data, which is ciphertext, is set via path w1 in response to assertion of TEXT-data write enable signal TEXT_WR and 0 values are set in the remaining low-order bits. Also, in CFB decryption mode, the operation value for operation mode signals (cfb|ofb) is 1, so that the selector SEL11 selects path w6 and the selector SEL12 selects path w5.

Then, the IV data are input to the encryption/decryption processing unit 1 via paths w6 and w7 to be subjected to encryption processing therein, and data w50 corresponding to the intermediate data Di of FIG. 3 is input to the exclusive OR processing unit 2. The TEXT data are also input to the exclusive OR processing unit 2 via paths w5 and w8, and an exclusive OR operation of the TEXT data and the IV data w50 which were subjected to the encryption processing is performed. Then, resulting decrypted data are sent to the encryption/decryption processing unit 1 via path w60 and high-order k bits, which is the effective value, is output as decrypted data O_DT.

Then, for the next decryption of TEXT data, the IV data in the IV register 4 is input via paths w6, w7, w9 and w10, and the TEXT data in the TEXT register 3 is input via paths w5, w8 and w12 to the CFB feedback section CFB_FB of the IV updating unit 50, subjected to bit processing, and set into the IV register 4 via path w70 in response to assertion of IV-data write enable signal IV_WR. Next, into the high-order k bits of the TEXT register 3, the following k-bit TEXT data are set via path w1 in response to assertion of TEXT-data write enable signal TEXT_WR and 0 values are set in the remaining low-order bits. Subsequently, decryption is repeated in a similar way.

Here, the CFB feedback section CFB_FB, which is common in FIGS. 8 and 9, is described. In FIG. 9, a first bit processing section 61 left-shifts IV data w10 for encryption or decryption by k bits and outputs it as data w91. The selector SEL34 switches between encrypted data w11 at the time of encryption and TEXT data w12 at the time of decryption with operation mode signals cfb and dec as control input. That is to say, during CFB encryption, the selector SEL34 outputs encrypted data w11 as data w93 in response to assertion of CFB mode signal cfb, and during CFB decryption, it outputs TEXT data w12 as data w93 in response to assertion of CFB mode signal cfb and DEC signal dec. A second bit processing unit 63 outputs the high-order k bits of input data w93 as data w92. And finally the CFB feedback section CFB_FB adds the k-bit data w92 to the low-order k bits of data w91 which has been left-shifted by k bits in the first bit processing section and outputs the resulting data as new IV data w71.

The operations illustrated above correspond with the behavior of CFB mode described in FIG. 3.

OFB Mode

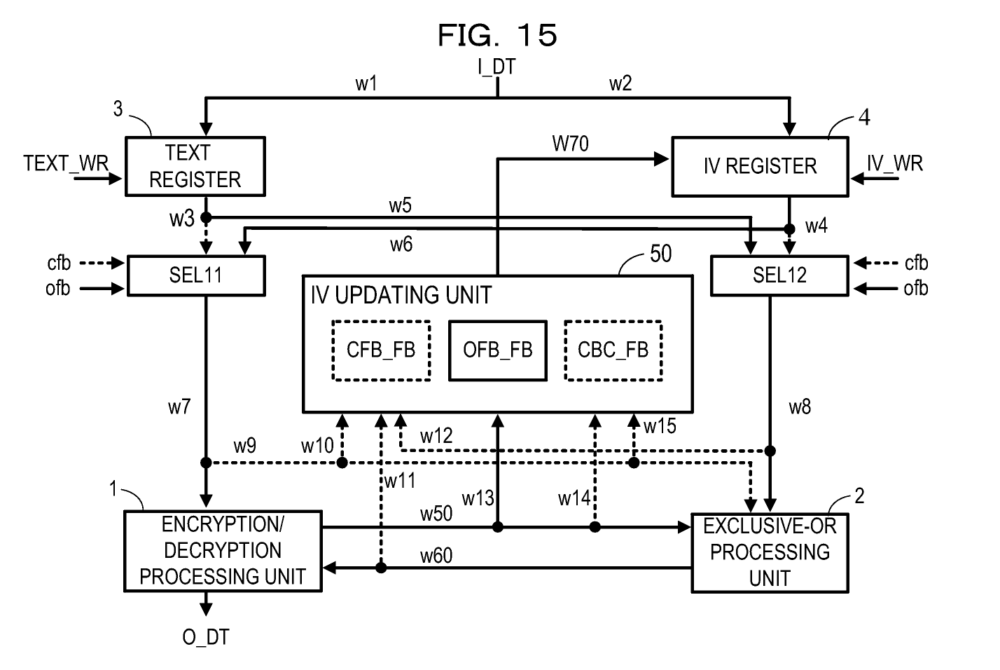

FIG. 15 illustrates operations of the encryption/decryption circuit of the first embodiment in encryption and decryption in OFB mode.

In encryption, for the first encryption of TEXT data, the initial value of IV data are set into the IV register 4 via path w2 in response to assertion of IV-data write enable signal IV_WR. Next, TEXT data are set into the TEXT register 3 via path w1 in response to assertion of TEXT-data write enable signal TEXT_WR. In OFB encryption mode, the operation value for operation mode signals (cfb|ofb) is 1, so that the selector SEL11 selects path w6 and the selector SEL12 selects path w5.

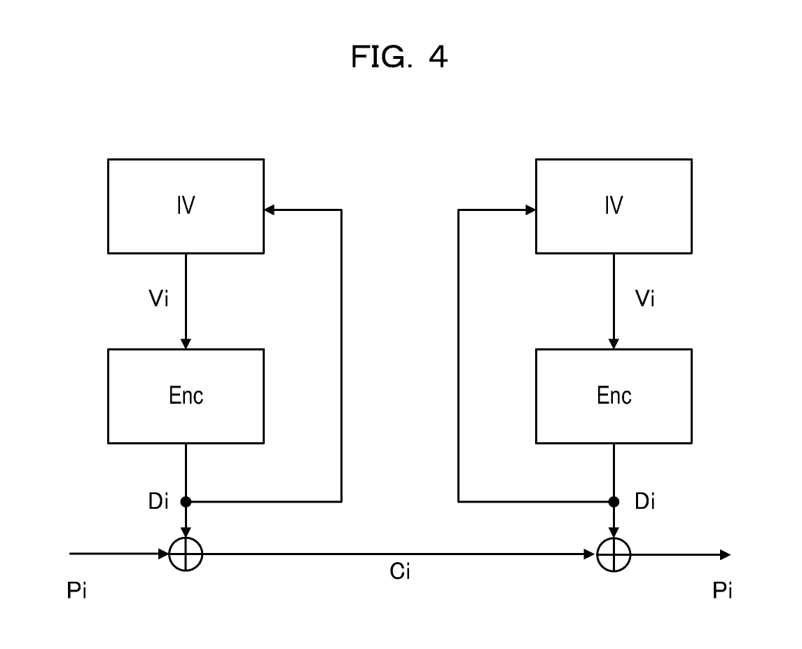

Then, the IV data are input to the encryption/decryption processing unit 1 via paths w6 and w7 to be subjected to encryption processing therein, and data w50 which corresponds to the intermediate data Di of FIG. 4 is input to the exclusive OR processing unit 2. The TEXT data are also input to the exclusive OR processing unit 2 via paths w5 and w8, and an exclusive OR operation of the TEXT data and the IV data w50 which were subjected to the encryption processing is performed. Then, resulting encrypted data are sent to the encryption/decryption processing unit 1 via path w60 and output as encrypted data O_DT.

Then, for the next encryption of TEXT data, the aforementioned intermediate data Di is input to the OFB feedback section OFB_FB of the IV updating unit 50 via paths w50 and w13, and set into the IV register 4 via path w70 in response to assertion of IV-data write enable signal IV_WR. The OFB feedback section OFB_FB is merely a feedback path as illustrated in FIG. 9. Next, into the TEXT register 3, TEXT data are set via path w1 in response to assertion of TEXT-data write enable signal TEXT_WR. Subsequently, encryption is repeated in a similar way.

Meanwhile, in decryption, the initial value of IV data are set in the IV register 4 via path w2 in response to assertion of IV-data write enable signal IV_WR for the first decryption of TEXT data. Then, TEXT data, which is ciphertext, is set into the TEXT register 3 via path w1 in response to assertion of TEXT-data write enable signal TEXT_WR. In OFB decryption mode, the operation value for operation mode signals (cfb|ofb) is 1, so that the selector SEL11 selects path w6 and the selector SEL12 selects path w5.

Then, the IV data are input to the encryption/decryption processing unit 1 via paths w6 and w7 to be subjected to encryption processing therein, and data w50 which corresponds to the intermediate data Di of FIG. 4 is input to the exclusive OR processing unit 2. The TEXT data are also input to the exclusive OR processing unit 2 via paths w5 and w8, and an exclusive OR operation of the TEXT data and the IV data w50 which were subjected to the encryption processing is performed. Then, resulting decrypted data are sent to the encryption/decryption processing unit 1 via path w60 and output as decrypted data O_DT.

Then, for the next decryption of TEXT data, the aforementioned intermediate data Di is input to the OFB feedback section OFB_FB of the IV updating unit 50 via paths w50 and w13, and set in the IV register 4 via path w70 in response to assertion of IV-data write enable signal IV_WR. Next, TEXT data are set into the TEXT register 3 via path w1 in response to assertion of TEXT-data write enable signal TEXT_WR. Subsequently, decryption is repeated in a similar manner. The operations illustrated above correspond with the behavior of OFB mode described in FIG. 4.

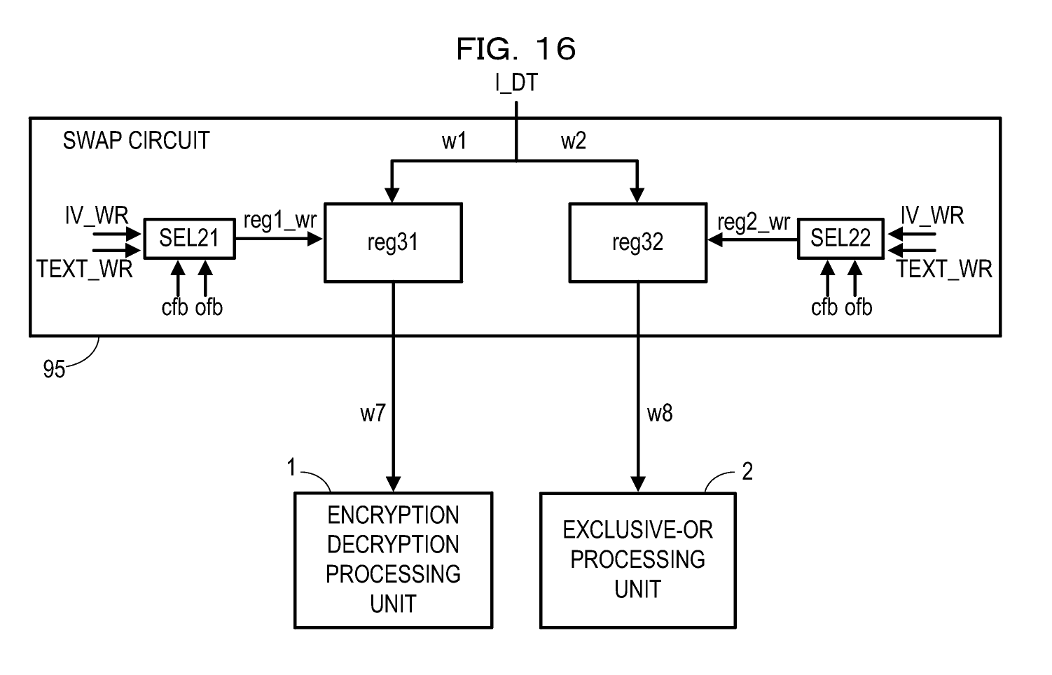

FIG. 16 illustrates a configuration of a swap circuit for use in the encryption/decryption circuit of a second embodiment. The swap circuit 95 has a register reg31, a register reg32, a selector SEL21, and a selector SEL22. Reference numerals w1, w2, w7, and w8 denote paths or data that is sent on the paths. An overview of the second embodiment will be illustrated first. The swap circuit 95 has common registers reg31 and reg32 in which either TEXT data or IV data, which are input data I_DT, is set. To the registers reg31 and reg32, write enable signal reg1_wr and reg2_wr which indicate TEXT-data write enable signal TEXT_WR or IV-data write enable signal IV_WR is asserted from the selectors SEL21 and SEL22 in accordance with requirements of an operation mode. As a result, either TEXT data or IV data are set in each of the registers reg31 and reg32. The data set in the register reg31 is input to the encryption/decryption processing unit 1 via path w7 and the data set in the register reg32 is input to the exclusive OR processing unit 2 via path w8. That is to say, in the swap circuit 95, processing to be performed on data set in the registers is fixed and either TEXT data or IV data are set in each of the registers depending on an operation mode.

The swap circuit 90 of the first embodiment may require selectors SEL11 and SEL12 that have the similar bit length as the register length in order to switch between the TEXT register and the IV register. On the other hand, the swap circuit 95 of the second embodiment employs 1-bit long selectors SEL21 and SEL22 in order to assert write enable signals reg1_wr and reg2_wr appropriate for an operation mode to the registers reg31 and reg32, and selects either one of the write enable signals. That is to say, to support the different modes of operation of the DES method, for example, the swap circuit 90 of the first embodiment may require two 64-bit long selectors, whereas the swap circuit 95 of the second embodiment may use two one-bit long selectors. According to the second embodiment, it may be thereby possible to reduce bit-length of selectors and wires, which may make circuits smaller and consume less electric power.

By using the selector of the second embodiment, divided input of data may be realized with a simple configuration. For example, when 32-bit data are input twice to a 64-bit long register for DES method, similar input processing to that described above may be performed using a one-bit selector for each 32-bit register. In other words, when data are to be input being divided into blocks, the data may be handled with several-bit selectors corresponding to the number of blocks.

The operations of components of the swap circuit 95 will be now described. The registers reg31 and reg32 are common registers in which either TEXT data or IV data, which are input data I_DT, is set, and the individual pieces of input data I_DT is input from the similar path.

The selector SEL21 outputs write enable signal reg1_wr to the register reg31 with operation mode signals cfb and ofb as control inputs and with TEXT-data write enable signal TEXT_WR and IV-data write enable signal IV_WR as inputs. In other words, the selector SEL21 selects either TEXT-data write enable signal TEXT_WR or IV-data write enable signal IV_WR in accordance with operation mode signals cfb and ofb, and outputs the selected signal as write enable signal reg1_wr to the register reg31.

In ECB and CBC modes, the operation value (cfb|ofb) is 0 and TEXT_WR is asserted to the register reg31 as write enable signal reg1_wr. In CFB and OFB modes, the operation value (cfb|ofb) is 1 and IV_WR is asserted to the register reg31 as write enable signal reg1_wr. When write enables signal reg1_wr is TEXT_WR, TEXT data are set in the register reg31, and when write enables signal reg1_wr is IV_WR, IV data are set in the register reg31.

The selector SEL22 performs similar operations, but an enable signal it selects for operation mode signals cfb and ofb is the reverse of the one selected by the selector SEL21. That is to say, in ECB and CBC modes, the operation value (cfb|ofb) is 0, so that IV_WR is asserted to the register reg32 as write enable signal reg2_wr. In CFB and OFB modes, the operation value (cfb|ofb) is 1, so that TEXT_WR is asserted to the register reg32 as write enable signal reg2_wr.

Data set in the register reg31 is input to the encryption/decryption unit 1 via path w7 and subjected to encryption or decryption processing therein. The data set in the register reg32 is input to the exclusive OR processing unit 2 via path w8 and is subjected to exclusive OR processing therein.

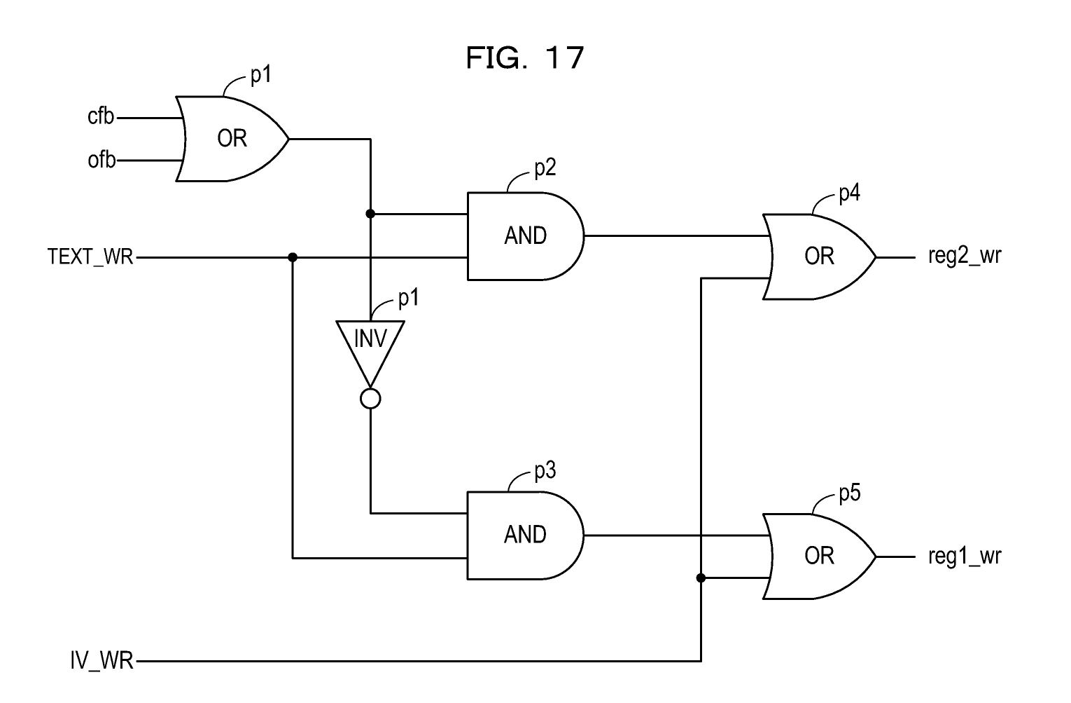

FIG. 17 illustrates an example of a selector circuit provided in the swap circuit according to the second embodiment. Using FIGS. 16 and 17, a procedure of setting TEXT data and IV data in registers in the different modes of operation will be illustrated below.

In ECB or CBC modes, output from OR gate p1 is (cfb|ofb)=0. Then, to set IV data first, TEXT-data write enable signal TEXT_WR becomes 0 and IV-data write enable signal IV_WR becomes 1. Accordingly, the selector circuit illustrated in FIG. 17 outputs IV-data write enable signal IV_WR=1 as write enable signal reg1_wr=1 from OR gate p5 and as write enable signal reg2_wr=1 from OR gate p4. Then, the write enable signals reg1_wr and reg2_wr are asserted to the registers reg31 and reg32, respectively, and IV data as input data I_DT is set into the registers. Next, for setting of TEXT data, TEXT-data write enable signal TEXT_WR becomes 1 and IV-data write enable signal IV_WR becomes 0. Accordingly, the selector circuit illustrated in FIG. 17 outputs TEXT-data write enable signal TEXT_WR=1 as enable signal reg1_wr=1 from OR gate p5 and as reg2_wr=0 from OR gate p4. Then, write enable signal reg1_wr is asserted to the register reg31 and TEXT data as input data I_DT is set therein. The register reg32 continues to maintain the aforementioned IV data because write enable signal reg2_wr=0. In such a manner, in ECB and CBC modes, TEXT data are set in the register reg31 and IV data are set in the register reg32.

Meanwhile, in CFB and OFB modes, output from OR gate p1 is (cfb|ofb)=1. To set IV data first, TEXT-data write enable signal TEXT_WR becomes 0 and IV-data write enable signal IV_WR becomes 1. Accordingly, the selector circuit illustrated in FIG. 17 outputs write enable signals reg1_wr=1 and reg2_wr=1 from OR gates p4 and p5. Then, the write enable signals reg1_wr and reg2_wr are asserted to the registers reg31 and reg32, respectively, and IV data as input data I_DT is set in the registers. Next, for setting of TEXT data, TEXT-data write enable signal TEXT_WR becomes 1 and IV-data write enable signal IV_WR becomes 0. Accordingly, the selector circuit illustrated in FIG. 17 outputs enable signals reg1_wr=0 and reg2_wr=1 from OR gates p4 and p5. Then, write enable signal reg2_wr is asserted to the register reg32 and TEXT data as input data I_DT is set therein. The register reg31 continues to maintain the aforementioned IV data because write enable signal reg1_wr=0. In such a manner, in CFB and OFB modes, IV data are stored in the register reg31 and TEXT data are stored in the register reg32, i.e., the reverse of ECB and CBC modes.

As described above, the selector circuit illustrated in FIG. 17 sets IV data in both the registers reg31 and reg32 regardless of the operation value (cfb|ofb) for operation mode signals cfb and ofb and thereafter sets TEXT data in one of the registers by overwriting it with TEXT data. And at the time of setting TEXT data, a register to be overwritten with TEXT data are determined in accordance with the operation value (cfb|ofb) for operation mode signals cfb and ofb. That is to say, operation mode may also be set after input of IV data, which provides the present selector circuit with the effect of increasing flexibility in order of setting.

Certain operations of the swap circuit 95 in the different modes of operation will be now described. According to the example, operation mode signal has been determined when IV data are to be set in a register. For example, in CBC mode, operation mode signals cfb and ofb are not asserted to the selectors SEL21 and SEL22, and the operation value (cfb|ofb) is 0. Therefore, in response to assertion of IV_WR which is selected as write enable signal reg2_wr, IV data as input data I_DT is set into the register reg32 via path w2. Also, in response to assertion of TEXT_WR selected as write enable signal reg1_wr, TEXT data as input data I_DT is set into the register reg31 via path w1. Consequently, the TEXT data set in the register reg31 is input to the encryption/decryption processing unit 1 via path w7 and the IV data set in the register reg32 is input to the exclusive OR processing unit 2 via path w8.

In CFB mode, since CFB mode signal cfb is asserted to the selectors SEL21 and SEL22 (i.e., cfb=1), the operation value (cfb|ofb) is 1. Therefore, in response to assertion of IV_WR selected as write enable signal reg1_wr, IV data as input data I_DT is set into the register reg31 via path w1. Also, in response to assertion of TEXT_WR selected as write enable signal reg2_wr, TEXT data as input data I_DT is set into the register reg32 via path w2. Consequently, the IV data set in the register reg31 is input to the encryption/decryption processing unit 1 via path w7 and the TEXT data set in the register reg32 is input to the exclusive OR processing unit 2 via path w8.

In OFB mode, since OFB mode signal ofb is asserted to the selectors SEL21 and SEL22 (i.e., ofb=1), the operation value (cfb|ofb) is 1 and data input processing similar to that in CFB mode is performed.

Now, a configuration of an encryption circuit using the swap circuit 95 that is capable of supporting all the modes of operation of the DES method is described.

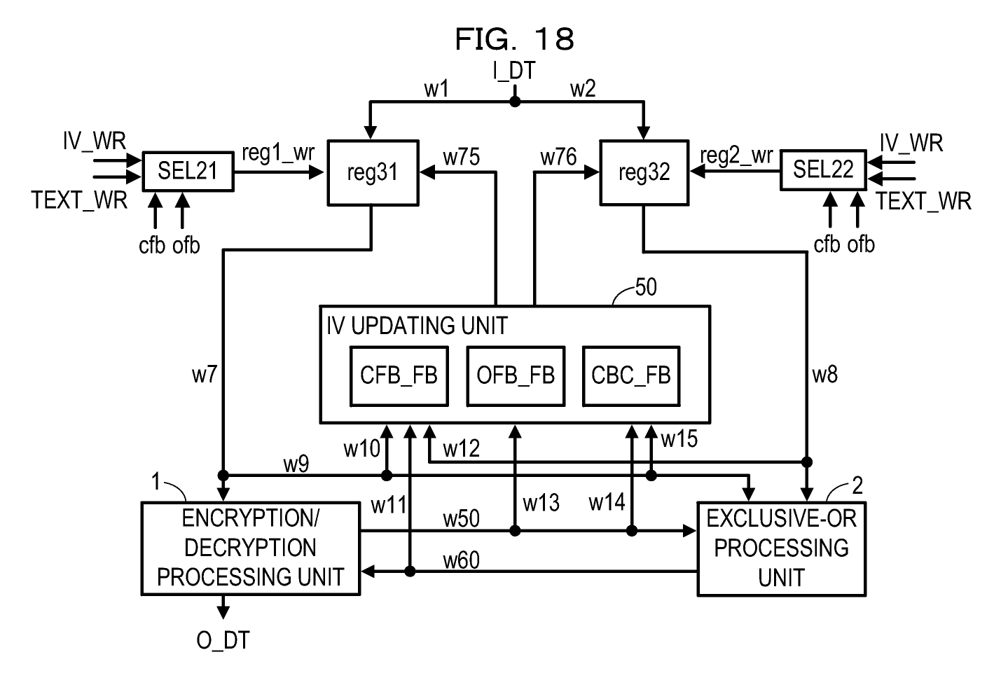

FIG. 18 schematically illustrates an encryption circuit which is configured with the swap circuit 95 and is capable of supporting all of the four modes of operation of the DES method. As this encryption circuit has the similar configuration as the first embodiment except the swap circuit portion, differences will be described below.

The IV updating unit 50 updates IV data in accordance with requirements of each operation mode and sets updated IV data into register reg31 or the register reg32 via path w75 or path w76.

Data input paths to the register reg31 are path w1 and path w75. In CFB and OFB modes, IV data to be used in the first encryption is set into the register reg31 via path w1 as mentioned above. IV data for use in the second and subsequent encryption is updated by the IV updating unit 50 and set into the register reg31 via path w75. Similarly, data input paths to the register reg32 are path w2 and path w76. In CBC mode, IV data to be used in the first encryption is set into the register reg32 via path w2. IV data for use in the second and subsequent encryption is updated by the IV updating unit 50 and set into the register reg32 via path w76.

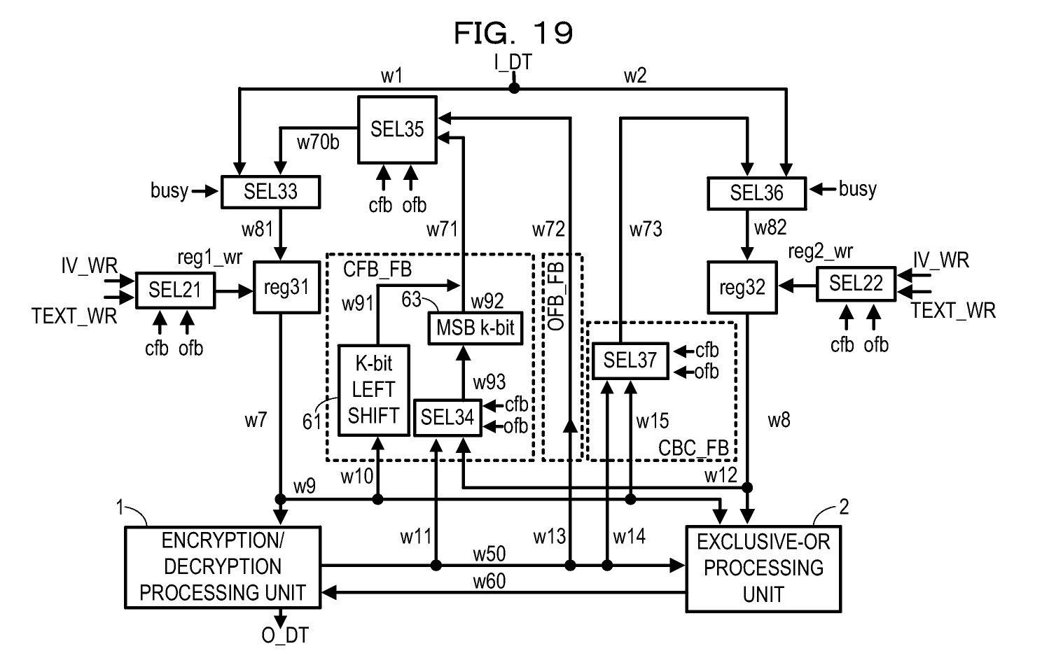

FIG. 19 illustrates an example of circuit configuration for the schematic diagram of FIG. 18. When compared with the exemplary circuit configuration in the first embodiment illustrated in FIG. 9, paths that are taken for setting output data w71, w72, and w73 into registers are different.

The selector SEL35 outputs either data w71 or w72 as data w70b in accordance with operation mode signal cfb and ofb. The selector SEL33 outputs input data w1 as data w81 when busy=0 and outputs input data w70b as data w81 when busy=1. The selector SEL36 outputs input data w2 as data w82 when busy=0 and outputs input data w73 as data w82 when busy=1.

In CBC mode, for example, busy is 0 when TEXT data and IV data are input in the first encryption, so that IV data are set in the register reg32 via path w2 and TEXT data are set in the register reg31 via path w1. Then, busy becomes 1 and an encryption operation is performed. After the first encryption, updated IV data are set into the register reg32 via paths w73 and w82 because busy=1. Then, busy becomes 0 and TEXT data are input from path w1 and path w2. At the time of the input, write enable signal reg1_wr for the register reg31 is 1 because of setting to CBC mode and TEXT data are set in the register reg31 as mentioned above. Meanwhile, write enable signal reg2_wr for the register reg32 is 0 and the register reg32 keeps the updated IV data. Then, busy becomes 1 and operation will be performed in a similar manner.

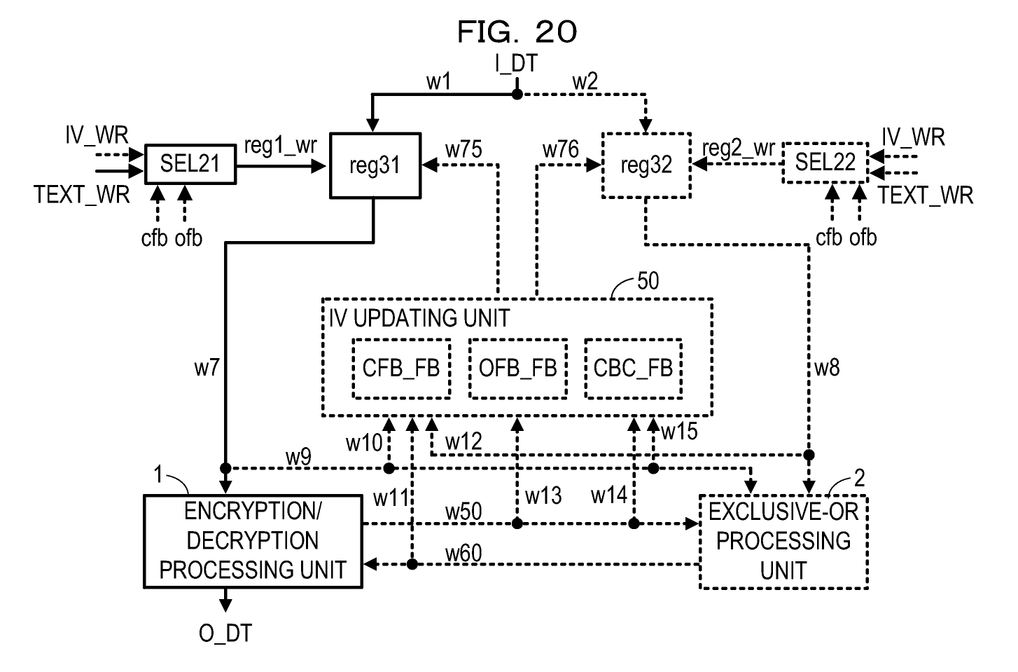

Hereinafter, operation in the different modes of operation will be described using FIG. 18 and with respect to FIGS. 20 to 25. In the figures, only paths that are used for data transmission during operation, operation mode signals that are asserted, and components that operate are illustrated by solid lines and other portions are illustrated by dotted lines.

ECB Mode

FIG. 20 illustrates operations of the encryption/decryption circuit of the second embodiment in encryption and decryption in ECB mode.

In ECB encryption mode, the operation value for operation mode signals (cfb|ofb) is 0 and TEXT data are set into the register reg31 via path w1 in response to assertion of TEXT_WR which is selected as write enable signal reg1_wr. Consequently, TEXT data are input to the encryption/decryption processing unit 1 via path w7, encrypted, and output. Subsequently, TEXT data are set into the register reg31 via path w1, encrypted by the encryption/decryption processing unit 1, and output as encrypted data O_DT in a similar way.

Meanwhile, in ECB decryption mode, the operation value for operation mode signals (cfb|ofb) is 0 and TEXT data, which is ciphertext, is set into the register reg31 via path w1 in response to assertion of TEXT_WR selected as write enable signal reg1_wr. Consequently, TEXT data are input to the encryption/decryption processing unit 1 via path w7, decrypted, and output. Subsequently, TEXT data are set into the register reg31 via path w1, decrypted by the encryption/decryption processing unit 1, and output as decrypted data O_DT in a similar way.

The operations illustrated above correspond with the behavior of ECB mode described in FIG. 1. In ECB mode, IV data are not used and the IV updating unit 50 does not operate.

CBC Mode

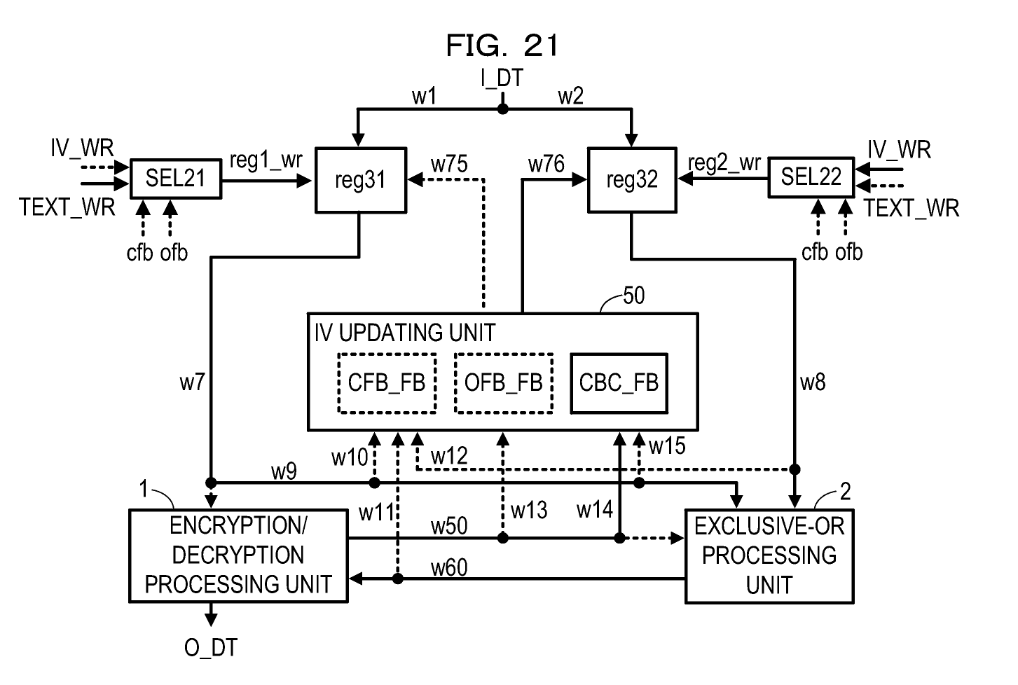

FIG. 21 illustrates operations of the encryption/decryption circuit of the second embodiment in encryption in CBC mode.

In CBC encryption mode, when the operation value for operation mode signals (cfb|ofb) is 0, the initial value of IV data are set into the register reg32 in response to assertion of IV_WR selected as write enable signal reg2_wr. Here, in the case of the selector of FIG. 17, the initial value of IV data are also set in the register reg31. Thereafter, TEXT data are set into the register reg31 in response to assertion of TEXT_WR selected as write enable signal reg1_wr.

Then, the TEXT data are input via paths w7 and w9 and the IV data are input via path w8 to the exclusive OR processing unit 2, in which an exclusive OR operation of the two is performed. Then, resulting data w60 which corresponds to the intermediate data Di of FIG. 2 is input to the encryption/decryption processing unit 1, subjected to encryption processing therein, and output as encrypted data O_DT.

Then, for the next encryption of TEXT data, the encrypted data O_DT mentioned above is input to the CBC feedback section CBC_FB of the IV updating unit 50 via paths w50 and w14, and set into the register reg32 via path w76 in response to assertion of IV-data write enable signal IV_WR. Next, to the register reg31, TEXT data are set via path w1 in response to assertion of TEXT_WR which is selected as write enable signal reg1_wr. Subsequently, encryption is repeated in a similar way.

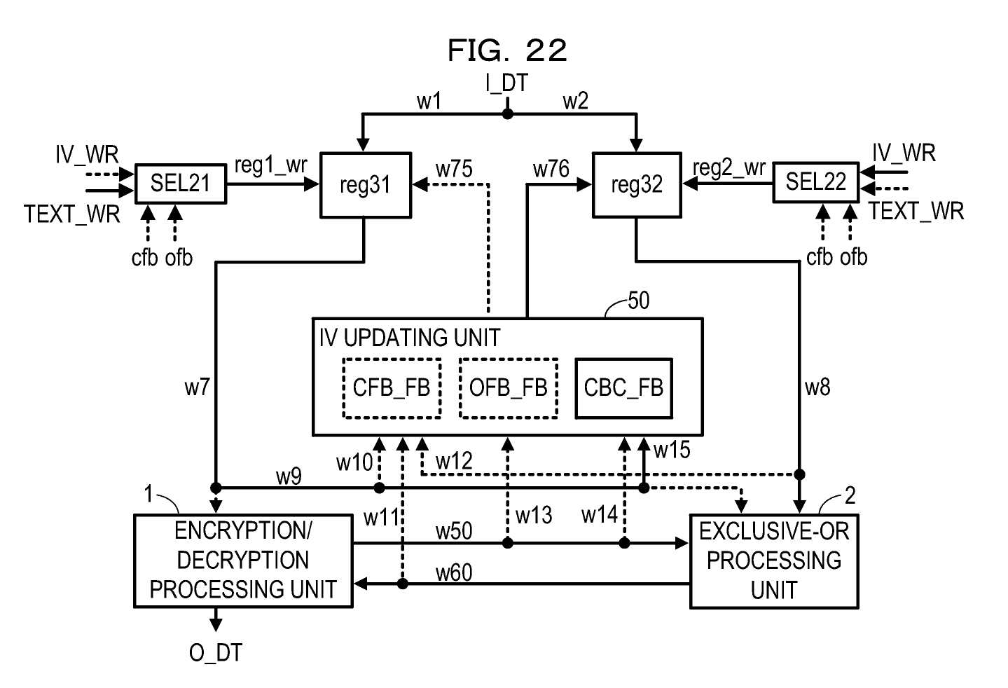

FIG. 22 illustrates operations of the encryption/decryption circuit of the second embodiment in decryption in CBC mode.

In CBC decryption mode, when the operation value for operation mode signals (cfb|ofb) is 0, the initial value of IV data are set into the register reg32 in response to assertion of IV_WR which is selected as write enable signal reg2_wr. Similarly, TEXT data are set into the register reg31 in response to assertion of TEXT_WR which is selected as write enable signal reg1_wr.

Then, the TEXT data are input to the encryption/decryption processing unit 1 via path w7 to be subjected to decryption processing therein, and data w50 corresponding to the intermediate data Di of FIG. 2 is input to the exclusive OR processing unit 2. The IV data are also input to the exclusive OR processing unit 2 via path w8, and an exclusive OR operation of the IV data and the TEXT data w50 which were subjected to the decryption processing is performed. Resulting decrypted data are then sent to the encryption/decryption processing unit 1 via path w60 and output as decrypted data O_DT.

Then, for the next decryption of TEXT data, the TEXT data in the register reg31 is input to the CBC feedback section CBC_FB of the IV updating unit 50 via paths w7, w9 and w15, and set into the register reg32 via path 76 in response to assertion of IV_WR selected as write enable signal reg2_wr. Next, TEXT data are set into the register reg31 via path w1 in response to assertion of TEXT_WR which is selected as write enable signal reg1_wr. Subsequently, decryption is repeated in a similar way.

The operations above correspond with the behavior of CBC mode described in FIG. 2.

CFB Mode

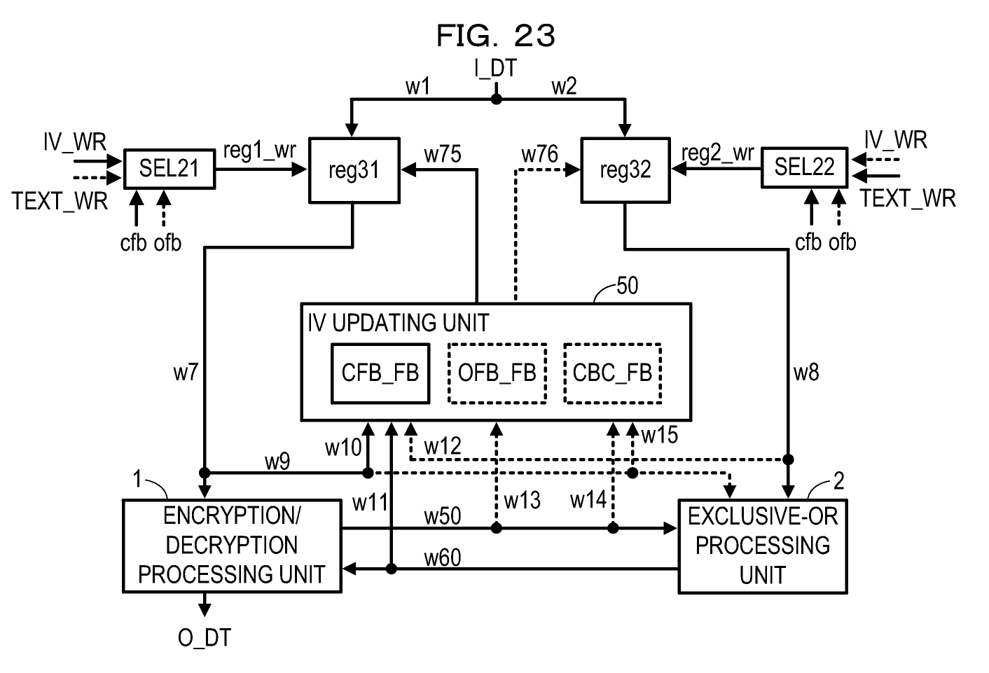

FIG. 23 illustrates operations of the encryption/decryption circuit of the second embodiment in encryption in CFB mode. As in the first embodiment, the high-order k bits of data are regarded as the effective value in encryption and decryption in CFB mode illustrated below.

In CFB encryption mode, when the operation value for operation mode signals (cfb|ofb) is 1, the initial value of 64-bit long IV data are set into the register reg31 in response to assertion of IV_WR which is selected as write enable signal reg1_wr. Similarly, k-bit long TEXT data are set into the high-order k bits of the register reg32 in response to assertion of TEXT_WR which is selected as write enable signal reg2_wr and 0 values are set in the remaining low-order bits.

Then, the IV data are input to the encryption/decryption processing unit 1 via path w7 to be subjected to encryption processing therein, and data w50 corresponding to the intermediate data Di of FIG. 3 is input to the exclusive OR processing unit 2. TEXT data are also input to the exclusive OR processing unit 2 via path w8, and an exclusive OR operation of the TEXT data and the IV data w50 which were subjected to the encryption processing is performed. Then, resulting encrypted data are sent to the encryption/decryption processing unit 1 via path w60 and high-order k bits as the effective value is output as encrypted data O_DT.

Then, for the next encryption of TEXT data, the IV data in the register reg31 is input via paths w7, w9 and w10, and the encrypted data mentioned above is input via paths w60 and w11 to the CFB feedback section CFB_FB of the IV updating unit 50, are subjected to the aforementioned bit processing, and set in the register reg31 via path w75 in response to assertion of IV_WR which is selected as write enable signal reg1_wr. Next, the following k-bit TEXT data are set into the high-order k bits of the register reg32 via path w2 in response to assertion of TEXT_WR which is selected as write enable signal reg2_wr and 0 values are set in the remaining low-order bits. Subsequently, encryption is repeated in a similar way.

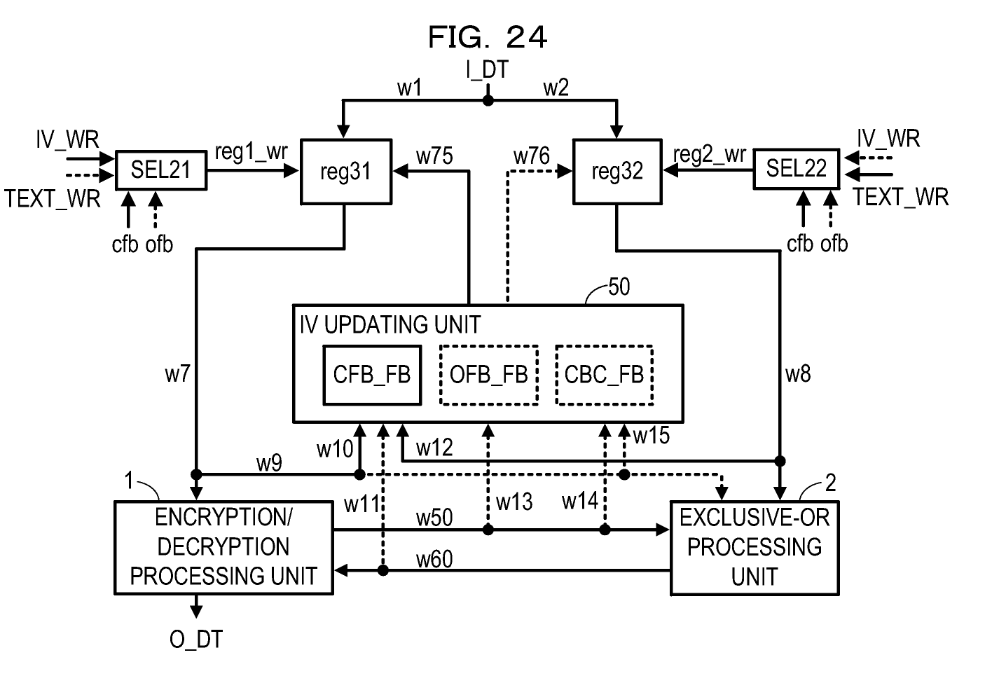

FIG. 24 illustrates operations of the encryption/decryption circuit of the second embodiment in decryption in CFB mode.

In CFB decryption mode, when the operation value for operation mode signals (cfb|ofb) is 1, the initial value of 64-bit long IV data are set into the register reg31 in response to assertion of IV_WR which is selected as write enable signal reg1_wr. Similarly, k-bit long TEXT data are set into the high-order k bits of the register reg32 in response to assertion of TEXT_WR which is selected as write enable signal reg2_wr and 0 values are set in the remaining low-order bits.

Then, the IV data are input to the encryption/decryption processing unit 1 via path w7 to be subjected to encryption processing therein, and data w50 corresponding to the intermediate data Di of FIG. 3 is input to the exclusive OR processing unit 2. TEXT data are also input to the exclusive OR processing unit 2 via path w8, and an exclusive OR operation of the TEXT data and the IV data w50 which were subjected to the encryption processing is performed. Then, resulting decrypted data are sent to the encryption/decryption processing unit 1 via path w60, and high-order k bits, which is the effective value, is output as decrypted data O_DT.

Then, for the next decryption of TEXT data, the IV data in the register reg31 is input via paths w7, w9 and w10, and the TEXT data in the register reg32 is input via paths w8 and w12 to the CFB feedback section CFB_FB of the IV updating unit 50, are subjected to the bit processing described above, and set in the register reg31 via path w75 in response to assertion of IV_WR which is selected as write enable signal reg1_w. Next, into the high-order k bits of the register reg32, the following k-bit TEXT data are set via path w2 in response to assertion of TEXT_WR which is selected as write enable signal reg2_wr, and 0 values are set in the remaining low-order k bits. Subsequently, decryption is repeated in a similar way.

The operations above correspond with the behavior of CFB mode described in FIG. 3.

OFB Mode

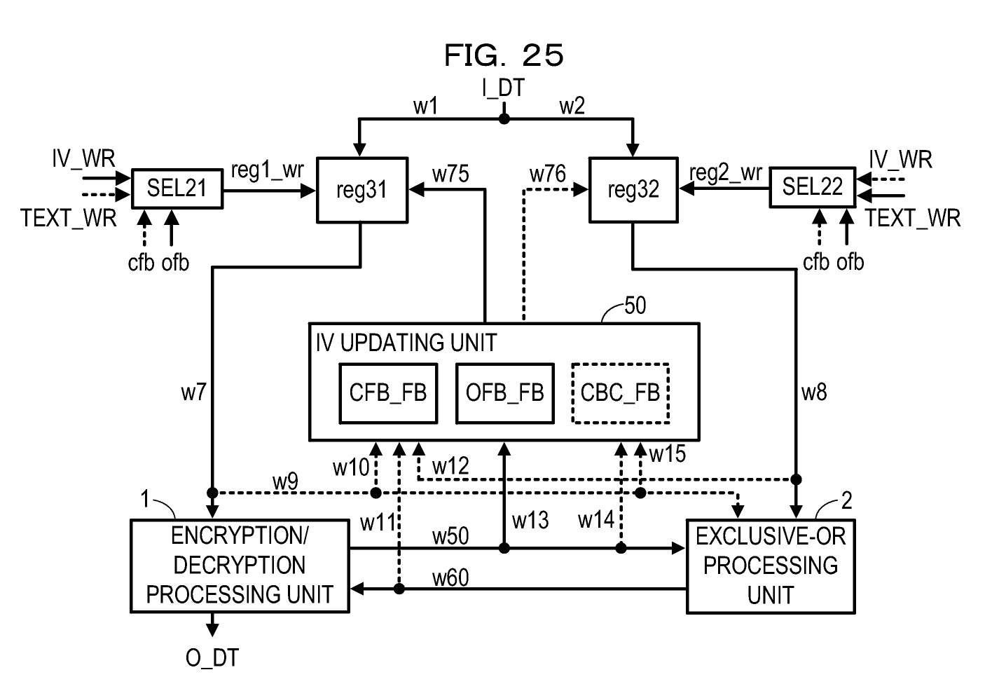

FIG. 25 illustrates operations of the encryption/decryption circuit of the second embodiment in encryption and decryption in OFB mode.

In OFB encryption mode, when the operation value for operation mode signals (cfb|ofb) is 1, the initial value of IV data are set into the register reg31 in response to assertion of IV_WR which is selected as write enable signal reg1_wr. Similarly, TEXT data are set in the register reg32 in response to assertion of TEXT_WR which is selected as write enable signal reg2_wr.

Then, the IV data are input to the encryption/decryption processing unit 1 via path w7 to be subjected to encryption processing therein, and data w50 corresponding to the intermediate data Di of FIG. 4 is input to the exclusive OR processing unit 2. The TEXT data are also input to the exclusive OR processing unit 2 via path w8, and an exclusive OR operation of the TEXT data and the IV data w50 which were subjected to the encryption processing is performed. Resulting encrypted data are then sent to the encryption/decryption processing unit 1 via path w60 and output as encrypted data O_DT.

Then, for the next encryption of TEXT data, the aforementioned intermediate data Di is input to the OFB feedback section OFB_FB of the IV updating unit 50 via paths w50 and w13, and set into the register reg31 via path w75 in response to assertion of IV_WR which is selected as write enable signal reg1_wr. Next, TEXT data are set into the register reg32 via path w2 in response to assertion of TEXT_WR which is selected as write enable signal reg2_wr. Subsequently, encryption is repeated in a similar way.

Meanwhile, in OFB decryption mode, when the operation value for operation mode signals (cfb|ofb) is 1, the initial value of IV data are set into the register reg31 in response to assertion of IV_WR which is selected as write enable signal reg1_wr. Similarly, TEXT data are set in the register reg32 in response to assertion of TEXT_WR which is selected as write enable signal reg2_wr.

Then, the IV data are input to the encryption/decryption processing unit 1 via path w7 to be subjected to encryption processing therein, and data w50 corresponding to the intermediate data Di of FIG. 4 is input to the exclusive OR processing unit 2. The TEXT data are also input to the exclusive OR processing unit 2 via path w8, and an exclusive OR operation of the TEXT data and the IV data w50 which were subjected to the encryption processing is performed. Resulting decrypted data are then sent to the encryption/decryption processing unit 1 via path w60 and output as decrypted data O_DT.

Then, for the next decryption of TEXT data, the aforementioned intermediate data Di is input to the OFB feedback section OFB_FB of the IV updating unit 50 via paths w50 and w13, and set into the register reg31 via path 75 in response to assertion of IV_WR which is selected as write enable signal reg1_wr. Next, TEXT data are set into the register reg32 via path w2 in response to assertion of TEXT_WR which is selected as write enable signal reg2_wr. Subsequently, decryption is repeated in a similar way.

The operations illustrated above correspond with the behavior of OFB mode described in FIG. 4.

According to the above-described embodiments, a small encryption/decryption circuit may be provided that may support the different modes of operation defined for the DES and/or AES method. The above-described embodiments may be applied to a swap circuit for swapping TEXT data and IV data in common key block cipher and an encryption/decryption circuit including the swap circuit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments have been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An encryption/decryption circuit, comprising:
a swap circuit for outputting each of text data and initialization vector data which are input from an input terminal to either a first or second output terminal in accordance with one of modes of operation;
an encryption/decryption processing unit to which one of the text data and the initialization vector data are input from the first output terminal and which performs encryption processing and decryption processing on the data; and
an exclusive OR processing unit to which another one of the initialization vector data and the text data are input from the second output terminal and which performs an exclusive OR operation on the data,
wherein the swap circuit comprises:
a first register for storing the text data;
a second register for storing the initialization vector data;
a first selector for selecting output from one of the first and second registers in response to the operation mode signal and outputting the selected output to the first output terminal; and
a second selector for selecting output from the other one of the first and second registers in response to the operation mode signal and outputting the selected output to the second output terminal, and
wherein the encryption/decryption circuit comprises an IV updating unit for outputting updated initialization vector data to the second register in accordance with output from the encryption/decryption processing unit, output from the exclusive OR processing unit, text data stored in the first register, and initialization vector data stored in the second register.

2. The encryption/decryption circuit according to claim 1,
wherein the modes of operation include CBC mode, and
wherein, when in the CBC mode, the first selector selects output from the first register, and the second selector selects output from the second register, and at a time of encryption, the exclusive OR processing unit performs an exclusive OR operation of the text data and the initialization vector data, the encryption/decryption processing unit subjects the data resulting from the exclusive OR operation to encryption processing, and the IV updating unit outputs the data subjected to the encryption processing to the second register as the updated initialization vector data.

3. The encryption/decryption circuit according to claim 1,
wherein the modes of operation include CBC mode, and
wherein, when in the CBC mode, the first selector selects output from the first register, and the second selector selects output from the second register, and at the time of decryption, the encryption/decryption processing unit subjects the text data to decryption processing, the exclusive OR processing unit performs an exclusive OR operation of the text data subjected to the decryption processing and the initialization vector data, and the IV updating unit outputs the text data to the second register as the updated initialization vector data.

4. The encryption/decryption circuit according to claim 1,
wherein the modes of operation include CFB mode, and
wherein, when in the CFB mode, the first selector selects output from the second register, and the second selector selects output from the first register, and at the time of encryption, the encryption/decryption processing unit subjects the initialization vector data to encryption processing, the exclusive OR processing unit performs an exclusive OR operation of the initialization vector data subjected to the encryption processing and the text data, and the IV updating unit subjects data resulting from the exclusive OR operation and the initialization vector data to bit operation processing, and outputs data resulting from the bit operation processing to the second register as the updated initialization vector data.

5. The encryption/decryption circuit according to claim 1,
wherein the modes of operation include CFB mode, and
wherein, when in the CFB mode, the first selector selects output from the second register, and the second selector selects output from the first register, and at the time of decryption, the encryption/decryption processing unit subjects the initialization vector data to encryption processing, the exclusive OR processing unit performs an exclusive OR operation of the initialization vector data subjected to the encryption processing and the text data, and the IV updating unit subjects the initialization vector data and the text data to bit operation processing, and outputs data resulting from the bit operation processing to the second register as the updated initialization vector data.

6. The encryption/decryption circuit according to claim 1,
wherein the modes of operation include OFB mode, and
wherein, when in the OFB mode, the first selector selects output from the second register, and the second selector selects output from the first register, and at the time of encryption and decryption, the encryption/decryption processing unit subjects the initialization vector data to encryption processing, the exclusive OR processing unit performs an exclusive OR operation of the initialization vector data subjected to the encryption processing and the text data, and the IV updating unit outputs the initialization vector data subjected to the encryption processing to the second register as the updated initialization vector data.

7. An encryption/decryption circuit, comprising:
a swap circuit for outputting each of text data and initialization vector data which are input from an input terminal to a first or second output terminal in accordance with one of modes of operation;
an encryption/decryption processing unit to which one of the text data and the initialization vector data are input from the first output terminal and which performs encryption processing and decryption processing on the data; and
an exclusive OR processing unit to which another one of the initialization vector data and the text data are input from the second output terminal and which performs an exclusive OR operation on the data,
wherein the swap circuit comprises:
first and second registers for each storing the text data or the initialization vector data in response to a text data write enable signal or an initialization vector data write enable signal and outputting the data to the first and second output terminals, respectively; and
a first selector for selecting one of the text data write enable signal and the initialization vector data write enable signal in response to the operation mode signal and supplying the selected signal to the first register, and a second selector for selecting the other one of the signals and supplying the selected signal to the second register, and
wherein the encryption/decryption circuit comprises an IV updating unit for outputting updated initialization vector data to the first or second register in accordance with output from the encryption/decryption processing unit, output from the exclusive OR processing unit, text data stored in the first or second register, and initialization vector data stored in the first or second register.

8. The encryption/decryption circuit according to claim 7,
wherein the modes of operation include CBC mode, and
wherein, when in the CBC mode, the first selector selects the text data write enable signal, and the second selector selects the initialization vector data write enable signal, and at a time of encryption, the exclusive OR processing unit performs an exclusive OR operation of the text data and the initialization vector data, the encryption/decryption processing unit subjects the data resulting from the exclusive OR operation to encryption processing, and the IV updating unit outputs the data subjected to the encryption processing to the second register as the updated initialization vector data.

9. The encryption/decryption circuit according to claim 7,
wherein the modes of operation include CBC mode, and
wherein, when in the CBC mode, the first selector selects the text data write enable signal, and the second selector selects the initialization vector data write enable signal, and at the time of decryption, the encryption/decryption processing unit subjects the text data to decryption processing, the exclusive OR processing unit performs an exclusive OR operation of the text data subjected to the decryption processing and the initialization vector data, and the IV updating unit outputs the text data to the second register as the updated initialization vector data.

10. The encryption/decryption circuit according to claim 7,
wherein the modes of operation include OFB mode, and
wherein, when in the OFB mode, the first selector selects the initialization vector data write enable signal, and the second selector selects the text data write enable signal, and at the time of encryption, the encryption/decryption processing unit subjects the initialization vector data to encryption processing, the exclusive OR processing unit performs an exclusive OR operation of the initialization vector data subjected to the encryption processing and the text data, and the IV updating unit subjects data resulting from the exclusive OR operation and the initialization vector data to bit operation processing, and outputs data resulting from the bit operation processing to the first register as the updated initialization vector data.

11. The encryption/decryption circuit according to claim 7,
wherein the modes of operation include CFB mode, and
wherein, when in the CFB mode, the first selector selects the initialization vector data write enable signal, and the second selector selects the text data write enable signal, and at the time of decryption, the encryption/decryption processing unit subjects the initialization vector data to encryption processing, the exclusive OR processing unit performs an exclusive OR operation of the initialization vector data subjected to the encryption processing and the text data, and the IV updating unit subjects the text data and the initialization vector data to bit operation processing, and outputs data resulting from the bit operation processing to the first register as the updated initialization vector data.

12. The encryption/decryption circuit according to claim 7,
wherein the modes of operation include CFB mode, and
wherein, when in the CFB mode, the first selector selects the initialization vector data write enable signal, and the second selector selects the text data write enable signal, and at the time of encryption and decryption, the encryption/decryption processing unit subjects the initialization vector data to encryption processing, the exclusive OR processing unit performs an exclusive OR operation of the initialization vector data subjected to the encryption processing and the text data, and the IV updating unit outputs the initialization vector data subjected to the encryption processing to the first register as the updated initialization vector data.

13. The encryption/decryption circuit according to claim 1, wherein the exclusive OR processing unit inputs both the text data and the initialization vector data from both the first and second output terminals.

14. The encryption/decryption circuit according to claim 7, wherein the exclusive OR processing unit inputs both the text data and the initialization vector data from both the first and second output terminals.

15. The encryption/decryption circuit according to claim 7, wherein after both the first and second selectors select the initialization vector data write enable signal and supply the signal to the first and second registers, one of the first and second selectors selects the text data write enable signal in response to an operation mode signal.

16. The encryption/decryption circuit according to claim 7, wherein, with multiple divided inputs of the text data and the initialization vector data input from the input terminal, the first and second registers are divided into a plurality of portions and the first and second selectors are provided for each of the divided portions of the first and second registers.

17. A method of encryption/decryption, comprising:
inputting each of text data and initialization vector data from an input terminal;
outputting the text data and the initialization vector data to either a first or second output terminal in accordance with one of modes of operation;
performing encryption processing and decryption processing on one of the text data and the initialization vector data;
exclusive OR-ing another one of the initialization vector data and the text data,
storing the text data in a first register of a swap circuit;
storing the initialization vector data in a second register of the swap circuit;
outputting updated initialization vector data to the second register;
selecting output from one of the first and second registers in response to an operation mode signal and outputting the selected output to the first output terminal; and
selecting output from the other one of the first and second registers in response to the operation mode signal and outputting the selected output to the second output terminal.
